(19) United States
(12) Patent Application Publication
(10) Pub. No.: US 2010/0280849 A1
(43) Pub. Date: Nov. 4, 2010

(54) Diagnostic System and Method for Amputation Risk Factor Identification and Amputation Prevention

(76) Inventor: Mark Hinkes, Nashville, TN (US)

Correspondence Address: Richard L. Sampson;SAMPSON & ASSOCIATES, P.C., 50 Congress Street, Boston, MA, 02109, US

(21) Appl. No.: 12/771,332

(22) Filed: Apr. 30, 2010

Related U.S. Application Data
(60) Provisional application No. 61/174,730, filed on May 1, 2009.

(51) Int. Cl. G06Q 50/00; G06F 17/30; G06F 15/16; G06F 3/048

(52) U.S. Cl. 705/3; 705/2; 707/769; 709/203; 707/E17.014

(57) ABSTRACT

A computer implemented diagnostic amputation prevention system and method for evaluating risk factors and generating risk assessments and recommendations for diabetic patients at risk for amputation is provided. The system includes a diagnostic computer having a neurological/vascular module configured to electronically query and receive information related to pedal pulses, monofilament testing device results, or combinations thereof. A skeletal module electronically queries and receives Osseous Deformity information, and a database stores and aggregates the received information. A results module identifies risk factors using the aggregated information and generates diagnostics and recommendations based on factors including the amount, type, and particular combination of identified risk factors. The diagnostics and recommendations include identification of amputation risk assessment categories, explanation of risk categories, identified risk factors, recommendations for treatment, and combinations thereof.

### RELATED APPLICATION

This application claims the benefit of U.S. Provisional Patent Application Ser. No. 61/174,730, entitled Podiatric Diagnostic System and Method, filed on May 1, 2009, the contents of which are incorporated herein by reference in their entirety for all purposes.

### BACKGROUND

1. Technical Field

This invention relates to web-enabled diagnostic transactions, and more particularly to an automated system and method for early identification of risk factors for foot ulcers, infections and amputations combined with recommendations for prevention based on the identified risk factors.

2. Background Information

Diabetes as a disease is a worldwide and growing problem. On Apr. 30, 2010 in the United States there were 24 million diabetics, 57 million pre-diabetics and 7 million undiagnosed diabetic patients. Diabetes is a unique disease that results when the pancreas, the organ responsible for the manufacture of insulin, either fails to produce insulin (type 1 diabetic) or the insulin that is manufactured is not sufficient for the body or the body cannot use the insulin that it produces (type 2 diabetic). The resulting chronically elevated blood sugar (glucose) levels result in vascular and neurological disease. The smallest vessels, called arterioles, become narrowed or totally closed. Oxygen and nutrients do not reach the nerves. This results in damage to the nerve that negatively affects the nerve function. The most frequent sites affected are the eyes, the kidneys, and the small vessels that nourish the nerves that travel to the foot. The loss of nerve function results in loss of vision, loss of kidney function, and loss of protective sensation to the foot.

Usually first observed as a tingling sensation, diabetic neuropathy often results in loss of protective sensation in the feet. This makes patients especially vulnerable to silent or painless trauma. For example, the patient may not feel a stone in their shoe or something dropping on their foot. They might use an over-the-counter product that contains salicylic acid that destroys tissue painlessly. Or, they might not feel exposure to extreme heat, putting their feet close to an open fire or heater and not being aware of a burn to the skin.

Once exposed to such trauma, patients with diabetes have several factors working against them to prevent or delay healing. They may include elevated blood glucose levels, a malfunctioning immune system, peripheral arterial disease (PAD) or peripheral venous disease (PVD), smoking, and simply not practicing preventive foot behaviors, such as wearing shoes to cover, support, and protect the foot or visually inspecting their feet on a daily basis.

Amputations of lower extremities done for patients with diabetes are neither rare nor extreme. In the United States, more than 90,000 amputation procedures are performed yearly at a cost of more than $13 billion. Worldwide, 1 million lower extremity amputations are done for patients with diabetes. That's one every 30 seconds. What's worse is that approximately 38% of patients who lose a leg will lose the other within three years. Nearly half of those who lose a leg won't survive five years. The five year mortality rate for diabetic patients with amputation is worse than all forms of cancer combined (excluding pancreatic and lung cancers). By 2025, a Yale University Study predicts, there will be more than 330,000,000 diabetic patients worldwide.

The cost of caring for these patients is rising quickly. Diabetes has recently been ranked as the 9^{th} most expensive condition to treat with total expenditures over $218 Billion in the USA. Between 1987-2000, spending on diabetes increased over 111 percent. The costs of caring for the pedal complications are great: treatment of an infected foot ulcer currently costs between $10-$15,000, a partial foot amputation currently costs between $17-$25,000, a below or above-the-knee amputation currently costs between $50-$75,000. The lifetime cost of rehabilitation may run well over $150,000.

According to the U.S. Centers for Disease Control, comprehensive foot care programs may potentially reduce lower extremity amputations in diabetic patients by 45% to 85%. This, however, has not yet happened. Caring for the diabetic foot is a puzzle whose pieces, heretofore, have not been placed together correctly.

The problem is not a lack of information. Significant information is available on the subject. However, many physicians and allied health care providers lack the training, the ability, the expertise, and the methodology to identify the risk factors and the associated with the multiple variables that can affect diabetic patients. This failure to identify the problem, formulate a cohesive and appropriate treatment plan that is based in evidence based medicine, and appropriately manage these medical problems often times results in needless lower extremity amputations.

Moreover, while strategies have been developed to identify patients with these problems, none of the existing strategies has the ability to identify the multiple variables associated with the risk factors, integrate them via an organized methodology into a standardized plan for amputation prevention.

A need therefore exists for a system and method that addresses the foregoing unresolved issues.

### SUMMARY

One aspect of the invention is a computer implemented diagnostic amputation prevention system for evaluating risk factors and generating risk assessments and recommendations for diabetic patients at risk for amputation. The system includes a diagnostic computer having a patient intake module configured to electronically query and receive patient demographic information and test administration information. A medical history module electronically queries and receives patient health information relating to obesity, circulation, allergies, vascular surgeries, bone infections, foot or leg surgical procedures, and medications. A visual documentation module is configured to electronically query and receive images of the patient's feet. A referral information module is configured to electronically query and receive patient referral information. A functional/social/foot health module is configured to electronically query and receive information related to the patient's shoes, previous amputations, Charcot Foot, Foot Care, Appearance, Use of Hands, Balance and Falling, Vision, Social support, and combinations thereof. A presenting foot complaints module electronically queries and receives information related to patient complaints, onset and duration of the complaints, quality and intensity of pain, location of pain, previous treatments and results, and combinations thereof. A neurological/vascular module electronically queries and receives information related to pedal pulses, digital capillary return, varicose veins, monofilament testing device results, forefoot interspace pain, deep tendon reflexes, and combinations thereof. A skeletal module electronically queries and receives Osseous Deformity information related to Hallux Abducto Valgus, Hallux Limitus/Rigidus, Digital Deformities including Hammer Toe, Mallet Toe, Claw Toe, Tailor's Bunion, Overlapping Digits, Charcot Foot and combinations thereof. An Integument module electronically queries and receives information related to integrity of the skin of the legs and feet, location of Keratosis, condition of nails, ulcers, and combinations thereof. A biomechanical exam module electronically queries and receives information related to gait, balance, muscle strength, joint range of motion, and foot biomechanical exam. A results module is configured to aggregate the information received to identify risk factors and generate diagnostics and recommendations based on factors including one or more of number, type, and particular combination of identified risk factors, the diagnostics and recommendations being selected from among amputation risk assessment category, explanation of risk categories, identified risk factors, recommendations for treatment, and combinations thereof.

Another aspect of the invention is a computer implemented diagnostic amputation prevention system for evaluating risk factors and generating risk assessments and recommendations for diabetic patients at risk for amputation. The system includes a diagnostic computer having a neurological/vascular module configured to electronically query and receive information related to pedal pulses, monofilament testing device results, or combinations thereof. A skeletal module electronically queries and receives Osseous Deformity information, and a database stores and aggregates the received information. A results module identifies risk factors using the aggregated information and generates diagnostics and recommendations based on factors including the amount, type, and particular combination of identified risk factors. The diagnostics and recommendations include identification of amputation risk assessment categories, explanation of risk categories, identified risk factors, recommendations for treatment, and combinations thereof.

Still another aspect of the invention is a computer implemented method for evaluating risk factors and generating risk assessments and recommendations for diabetic patients at risk for amputation. The method includes querying and receiving, with a neurological/vascular computer module, information relating to pedal pulses, monofilament testing device results, or combinations thereof. The method further includes querying and receiving, with a skeletal computer module, Osseous Deformity information. The received information is aggregated in a database, and a results module identifies risk factors for amputation using the aggregated information. The results module also generates diagnostics and recommendations based on factors including amount, type, and particular combination of identified risk factors. The diagnostics and recommendations include identification of amputation risk assessment categories, explanation of risk categories, identified risk factors, recommendations for treatment, and combinations thereof.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of one embodiment of a network-based transaction facility of the present invention;

FIG. 2 is a block diagram of one embodiment of a database maintained by a database engine server of the embodiment of FIG. 1;

FIG. 3 is a diagrammatic representation of one embodiment of a user table within the database;

FIG. 4 is a diagrammatic representation of an exemplary portion of an embodiment of a survey table within the database;

FIG. 5A is a block diagram of a simple embodiment of a network-based system of the present invention;

FIG. 5B is a block diagram of a more detailed embodiment of a network-based system of the present invention;

FIG. 6 is a block diagram of one embodiment of an interface module sequence configured to implement aspects of the embodiments of FIGS. 5A and 5B;

FIG. 7A is a flow chart of one embodiment of a method in accordance with embodiments of the present invention;

FIG. 7B is a flow chart showing optional steps usable in combination with the embodiment of FIG. 7A;

FIGS. 8-27 are exemplary representations of various user interfaces generated by the interface modules of FIG. 6; and

FIG. 28 is a block diagram of one embodiment of a computer system used in connection with embodiments of the present invention.

### DETAILED DESCRIPTION

Throughout this application, various publications, patents and published patent applications are referred to by an identifying citation. The disclosures of the publications, patents and published patent applications referenced in this application are hereby incorporated by reference into the present disclosure.

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents.

### General Overview

A web-based method and application for foot ulcer, infection and lower extremity amputation prevention in diabetic and other “at risk” patients, is described. The system provides a standardized, evidence based medicine approach, which identifies each patient's individual risk factors, stratifies the patient into risk categories and provides recommendations for a custom tailored amputation prevention program.

In particular embodiments, such a method and apparatus are provided in connection with a network-based transaction facility, and will be so described, with the understanding that off-line or stand-alone versions may also be provided without departing from the scope of the present invention.

In the following description, for purposes of explanation, numerous specific details are set forth in order to provide a thorough understanding of the present invention. It will be evident, however, to one skilled in the art that the present invention may be practiced without these specific details.

The present inventor has developed a web based system configured to generate a “survey” (also variously referred to herein as the “inventive survey”, “test” or “exam”) that evaluates diabetic and other “at risk” patients on a multivariable basis and identifies each patient's risk factors for foot ulcers, infections, and amputations. By identifying specific parameters/variables associated with each patient, risk factors may be identified and a risk profile can be created. The risk profile may be measured against, for example, conventional evaluation schemes such as that created by the International Working Group On The Diabetic Foot (www.iwgdf.org), which is generally accepted by those skilled in the art as the worldwide standard for evaluating, stratifying and managing the diabetic foot. Based on those identified risks, embodiments of the present invention create individualized treatment recommendations and/or patient education for prevention of ulcers, infections, and amputations.

Briefly described, an embodiment of the “survey” identifies a variety of risk factors and captures data including patient identification, medical history, referral information, functional social and foot health history, and presented foot complaints. It provides an organized and standardized method to evaluate a patient's risk factors by medical history, social/functional evaluation, physical exam including vascular and neurological evaluations and identification of skeletal and integumentary (soft tissue and nail) deformities that may contribute to pedal ulcers, infections, etc.

As Chief of Podiatry and Director of Podiatric Medical Education and Chairman of the Preservation Amputation Care and Treatment Program at the Veterans Affairs Medical Center, Tennessee Valley Healthcare System, and author of “Keep The Legs You Stand On,” (Nightengale Press, 2009) it has been one of the present inventors' personal and professional goals to reduce the rate of amputation for patients with diabetes. Indeed, this inventor has discovered that amputation prevention in patients with diabetes is possible, despite the failure of conventional approaches. Published research by the present inventor has demonstrated the validity of preventive foot health. Medical research confirms that preventive foot health approaches can decrease the number of foot ulcers and amputations.

Advantageously, the present embodiments are based on current scientific medical research and are easily updated to incorporate new medical research as it evolves. These embodiments are also standardized and integrated into a logical format to collect and assimilate a wide range of information relevant to amputation risk actors, to identify risk categories, and to design a customized foot health and amputation prevention program.

The instant inventor has found that embodiments of the present invention may be used to successfully identify those patients who demonstrate high-level risk factors such as decreased circulation, loss of protective sensation and pedal deformities. These embodiments have been found to help provide a thorough risk assessment and an individualized preventive care plan that can prevent a triggering event of mechanical, thermal or chemical origin that can lead to foot ulcers, infection, and ultimately, an amputation. By identifying those patients with risk factors that include foot deformities of the bones, soft tissues, or nails, and their vascular, neurological and pedal biomechanical status, prompt and proper treatment, including prosthetic items, such as shoes, insoles, braces, and walking aids, and on-going foot care may be provided.

Aspects of the invention include the recognition that those statistically most vulnerable for lower extremity amputations generally fall into Category 3, and to a lesser extent, Category 2, in the evaluation scheme of the aforementioned International Working Group for the Diabetic Foot. These patients generally have loss of protective sensation (LOPS) as defined by an inability to feel the 5.07/10 gm monofilament testing device on the bottom of their feet. They usually have a combination of autonomic, sensory or motor neuropathy that complicate healing of a foot wound. Many share a history of a previous amputation, foot ulcer, gangrene, claudication, rest pain, osteomyelitis, end-stage renal disease, previous vascular surgery on the legs, or a history of smoking.

With the foregoing in mind, embodiments of the present invention are configured to provide a: Vascular Evaluation of pulses in both feet; Neurological Evaluation with the 5.07/10 gm monofilament testing device to determine LOPS; and Foot Deformities Evaluation to classify osseous, soft tissue or nail deformities.

Osseous deformities include substantially any joint deformity of the foot such as hallux abducto valgus or bunion deformity, contracted digits that create hammer toe, claw toe, or mallet toe deformities and a tailor's bunion—a deformity of the 5th metatarsal-phalangeal joint and Charcot Foot deformity. Such bone deformities can create pressure points that rub against shoes or bedding, become inflamed, and lead to soft tissue breakdown or ulcers. Infected ulcers lead to osteomyelitis. The geriatric patient with diabetes will be challenged to heal these ulcers as they generally have neuropathy, PAD, PVD, and immunopathy. This combination of co-morbidities oftentimes delays or prevents healing, and because of infection and risk to the patient's life, leads to amputation. Pressure against bony structures causes the body to protect itself by creating soft tissue deformities, called keratosis. These thickened skin lesions are called corns or calluses. If they are left untreated an abscess can form underneath them. Undetected and unfelt, these abscesses can lead to osteomyelitis and result in amputation.

Nail deformities can also lead to amputation. A hypertrophic nail is vulnerable to pressure from the shoe pressing against it, causing an abscess underneath it. A thick, deformed and long nail can lacerate the adjacent digit. In both situations, if osteomyelitis results, amputation may be necessary.

The embodiments disclosed herein provide a solution to the problem of foot and leg amputations by effectively closing the gaps in foot care by a standardized, modular approach for identifying risk factors and generating multidisciplinary treatments. The system may also generate appropriate referrals to other disciplines, e.g., to evaluate patients and their specific risk factors such as glycemic control, smoking cessation, nutritional counseling, appropriate footgear, and on-going professional foot care. Each of these variables influences amputation prevention.

### Preventing A Triggering Event

As will be described in greater detail hereinbelow, the inventive modular system has effectively solved the puzzle of amputation prevention. The system identifies a variety of risk factors that contribute to amputation and evaluates each patient on a multivariable basis. It suggests opportunities to provide preventive care before a triggering event such as unrecognized mechanical, chemical or thermal trauma occurs to the foot. It has been found that in a preponderance of cases it is this silent or painless trauma to the foot that starts a process that leads to ulceration and the cascade of events that culminates in lower limb loss.

Additionally, the inventive system may be used as a template for quality management, e.g., for evaluation and documentation of the diabetic foot. It may be used to document mandated quality management foot exams for high-risk patients such as those on renal dialysis. Moreover, embodiments of the system may be accessed from any location having an Internet connection, 24 hours daily, 365 days a year.

Other optional modules of the system may be focused on educating patients and providers on prevention, identifying and addressing risks and risk factors, and providing timely and appropriate cost effective care.

These embodiments thus not only provide clinical evaluation and management capabilities but also house a database for patient data and research, including completed patient surveys, diagnostic reports and educational materials, and may provide a vehicle for communications for those parties wishing to discuss any aspect of the diabetic foot and amputation prevention. The inventive system may thus offer significant opportunities to reduce costs in the areas of Pharmacy, Labs and, especially Inpatient bed days, the most expensive part of diabetic foot care.

The various embodiments may be implemented in any of various clinical settings such as hospitals, outpatient clinics, wound care centers, and/or physician's offices. Because of its web based capabilities it may also be used via laptop or handheld data devices in remote locations, benefiting populations not close to the above-mentioned facilities. Potential users may include may include substantially any entities that take financial risk for diabetic patients, such as medical insurance companies, managed care companies, disease management companies, third party administrators, state supported medical clinics for the indigent, state and national business health coalitions, large employer groups, labor unions, and quality improvement organizations, as well as patients themselves. These embodiments may thus be incorporated into the structure of electronic medical records software companies to benefit both patient and physician and reduces healthcare costs. In this regard, the output generated by these embodiments may be printed for paper charting and/or exported in substantially any suitable electronic format to an electronic medical record.

The following Table I includes aspects of a comprehensive foot care program enabled by embodiments of the inventive system.

TABLE I

| I. | Identify Patients “At Risk” for Lower Extremity Amputation | |
|---|---|---|
| A. | Data Mining (Not all at risk patients are diabetic) A small % | |
| | have risk factors and are not diabetic. | |
| | 1. | We can identify at risk patients by diagnosis codes |
| | | (ICD-9 Codes) |

| | |
|---|---|
| a. | Diabetes Mellitus |
| b. | Neurological/Neuropathy |
| c. | Vascular/PAD/PVD |
| d. | Musculo-Skeletal |
| e. | Occular/Low Vision/Legally Blind |
| f. | Renal/ESRD |
| g. | Ortho/Pedal Deformities |
| h. | Medical History, e.g., Agent Orange |

| | |
|---|---|
| 2. | Current Procedure Terminology (CPT Codes) |

| | |
|---|---|
| a. | Ulcer Debridments |
| b. | Amputation Procedures |
| c. | Prosthetics |

| | 3. | Hospital Admissions |
|---|---|---|
| B. | Patient Screening | |
| | 1. | Foot exam. |
| II. | Identify Patient's Individual Amputation Risk Factors | |
| | A. | Standardized Evaluation Criteria/Care Algorithm |
| | B. | Examiner Training |
| | C. | Exam |

| | |
|---|---|
| 1. | Pedal Pulses |
| 2. | 10 Gm Monofilament Wire Test |
| 3. | Evaluation of Deformities |
| | a. Osseous |
| | b. Soft Tissue |
| | c. Nail |

| III. | Data Collection and Management | |
|---|---|---|
| | Stratify patients into Evaluation/Management Categories. | |
| | A. | Cat 0 |
| | B. | Cat 1 |
| | C. | Cat 2 |
| | D. | Cat 3 |
| IV. | Preventive Care Management/Recommendations for Patients | |
| | Based on E/M Category. | |
| | A. | Diabetes Education |
| | B. | Nutrition |
| | C. | Smoking Cessation |
| | D. | Blood Glucose Management |
| V. | Identify Preventive Foot Care Needs/Recommendations | |
| | A. | Shoes |

| | |
|---|---|
| 1. | DM shoes |
| 2. | Extra Depth Shoes |
| 3. | Custom Molded Shoes |

| | |
|---|---|
| B. | Socks |
| C. | Insoles |
| D. | Biomechanical Orthotics |
| E. | Braces |

| | |
|---|---|
| 1. | Ritchie Brace |
| 2. | Ankle Foot Orthosis |

| | |
|---|---|
| F. | On Going Foot Care |

| | |
|---|---|
| 1. | Opportunity for On Going Patient Education |
| 2. | Treatment of Nails |
| 3. | Treatment of Corns/Calluses |
| 4. | Evaluation of Insoles |

| | G. | Medications |
|---|---|---|
| | 1. | Antifungal, Antibacterial, Moisturizers |
| VI. | Patient Database/Registry | |
| | A. | Repository of selected patient information. |
| | B. | Able to monitor changes in patient pedal health |
| | C. | No patient falls thru the cracks/prevents gaps in care. |
| VII. | Interdisciplinary Care/System Accessible by Various Users | |
| | A. | Involves a variety of medical and surgical specialists |
| | | including, Primary Care, Endocrinologist, Infectious |
| | | Disease, Surgeon, Podiatrist, Diabetes Educator, |
| | | Nursing, Wound Care, Pharmacy, Lab, Dietitian, Social |
| | | Worker, Dentist, Psychologist, Psychiatrist, |
| | | Orthotist, Prosthetist. |
| | B. | Facilitates prompt, appropriate patient friendly care |
| | C. | Controls Costs |
| | D. | Prevents small issues from becoming large issues. |
| VIII. | Research Module | |
| | A. | The inventive system will over time accumulate a |
| | | significant amount of data concerning the diabetic |
| | | and “at risk” foot. |
| | B. | With appropriate patient protection and |
| | | confidentiality, the data could be used for |
| | | future research on amputation prevention. |

| | |
|---|---|
| IX. | (Optional) Limb Salvage Teams |
| A. | A specialized group of surgeons and medical specialists |
| | within the Interdisciplinary Care Team may access the |
| | system on behalf of particular patients, to track and |
| | evaluate and treat limb or life threatening lower |
| | extremity problems such as non healing wounds |
| | infections, ulcers or gangrene. |

### Terminology

For the purposes of the present specification, the term “transaction” shall be taken to include any communications between two or more entities and shall be construed to include, but not be limited to, commercial transactions including login, payment/subscription, transfer of information between client and server, and the like. The terms “computer” and “end-user device” are meant to encompass a workstation, personal computer, personal digital assistant (PDA), wireless telephone, or any other suitable computing device including a processor, a computer readable medium upon which computer readable program code (including instructions and/or data) may be disposed, and a user interface. Terms such as “server”, “application”, “engine” and the like are intended to refer to a computer-related component, including hardware, software, and/or software in execution. For example, an engine may be, but is not limited to being, a process running on a processor, a processor including an object, an executable, a thread of execution, a program, and a computer. Moreover, the various components may be localized on one computer and/or distributed between two or more computers. The terms “real-time” and “on-demand” refer to sensing and responding to external events nearly simultaneously (e.g., within milliseconds or microseconds) with their occurrence, or without intentional delay, given the processing limitations of the system and the time required to accurately respond to the inputs. Terms such as “component,” “module”, “control components/devices,” “messenger component or service,” and the like are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server (or control related devices) can be components. One or more components may reside within a process and/or thread of execution and a component may be localized on one computer and/or distributed between two or more computers or control devices.

### Programming Languages

The system and method embodying the present invention can be programmed in any suitable language and technology, such as, but not limited to: C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, such as, but not limited to, Microsoft SQL Server or IBM AS 400.

Referring now the accompanying figures, aspects of a representative embodiment of the inventive system of the present invention will be described. As mentioned above, the issue of lower extremity ulcers, infections, and amputations in patients with diabetes and other “at risk” patients and the difficulties associated with identifying, evaluating, and managing these patients and their medical issues have been problematic and financially costly. While some of these amputations may be necessary due to non-healing wounds, gangrene of the foot or leg, or to prevent systemic infection that may become life threatening, many others may not.

### Transaction Facility

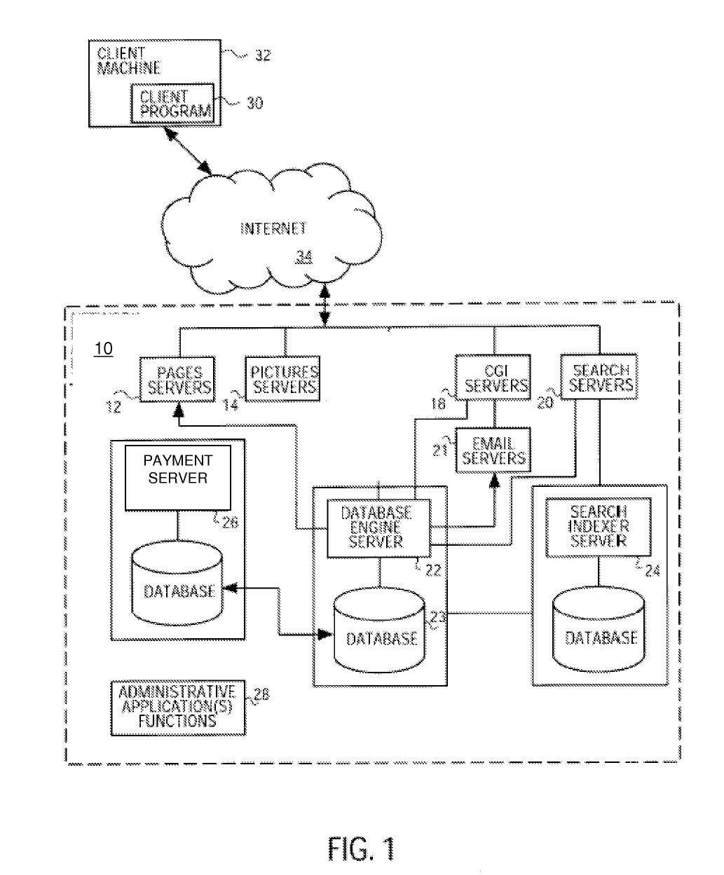

FIG. 1 is a block diagram illustrating an exemplary network-based transaction facility in the form of an Internet-based amputation prevention facility 10. The amputation prevention facility 10 includes one or more of a number of types of front-end servers, namely page servers 12 that deliver web pages (e.g., markup language reports), picture servers 14 that dynamically deliver images to be displayed within Web pages, CGI (Common Gateway Interface) servers 18 that provide an intelligent interface to the back-end of facility 10, and search servers 20 that handle search requests to the facility 10. E-mail servers 21 provide, inter alia, automated e-mail communications to users of the facility 10. The back-end servers may include a database engine server 22, a search index server 24 and a payment (e.g., credit card and/or subscription) database server 26, each of which may maintain and facilitate access to a respective database. Facility 10 may also include an administrative application server 28 configured to provide various administrative functions.

The network-based amputation prevention facility 10 may be accessed by a client program 30, such as a browser (e.g., the Internet Explorer distributed by Microsoft) that executes on a client machine 32 and accesses the facility 10 via a network such as, for example, the Internet 34. Other examples of networks that a client may utilize to access the amputation prevention facility 10 include a wide area network (WAN), a local area network (LAN), a wireless network (e.g., a cellular network), or the Plain Old Telephone Service (POTS) network.

### Database Structure

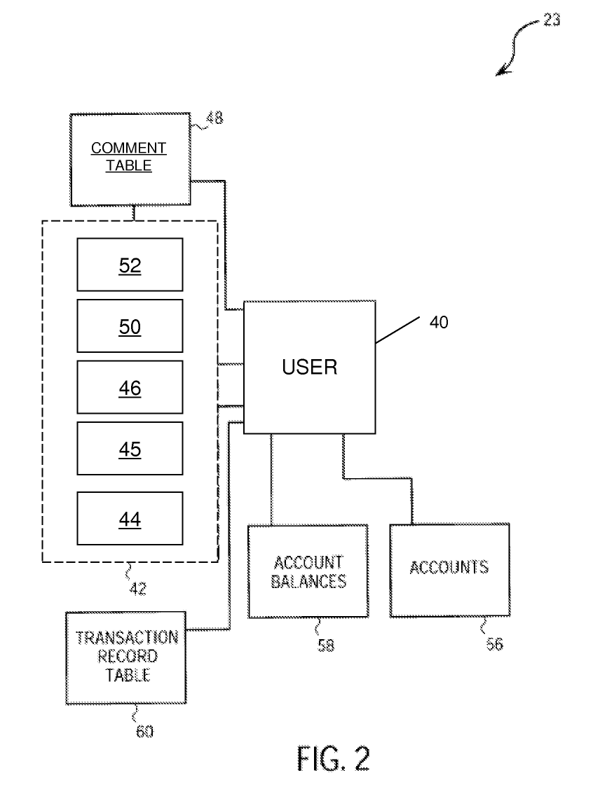

FIG. 2 is a database diagram illustrating an exemplary database 23, maintained by and accessed via the database engine server 22, which at least partially implements and supports the amputation prevention facility 10. The database 23 may, in one embodiment, be implemented as a relational database, and includes a number of tables having entries, or records, that are linked by indices and keys. In an alternative embodiment, the database 23 may be implemented as collection of objects in an object-oriented database.

As shown, central to the database 23 is a user table 40, which contains a record for each user of the amputation prevention facility 10. The database 23 also includes tables 42 that may be linked to the user table 40. Specifically, the tables 42 may include source material (e.g., survey questionnaire) content table 44, diagnostic report table 45, risk report table 46, additional resource table 51 and recommended product table 52. A user record in the user table 40 may be linked to one or more diagnostic/risk reports that are being, or have been, generated via the facility 10 and for which records exist within the tables 42.

The database 23 may also include a comment table 48 populatable with comment records that may be linked to one or more diagnostic report records within the diagnostic report tables 42 and/or to one or more user records within the user table 40. The comment records may include notations made by patients, physicians, or other care providers associated with the patient's care. A number of other tables may also be linked to the user table 40, such as an accounts table 56, an account balances table 58 and a transaction record table 60.

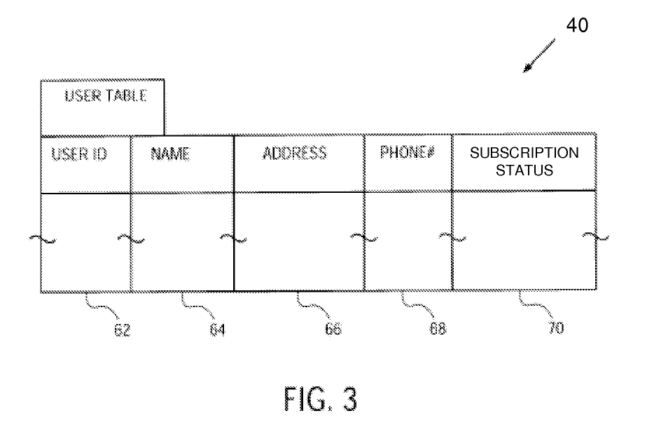

FIG. 3 is a diagrammatic representation of an exemplary embodiment of the user table 40 that is populated with records, or entries, for each user of the amputation prevention facility 10. As shown, table 40 includes a user identifier column 62 that stores a unique identifier for each user. A name column 64 may store a first name, a middle initial and a last name for each user. An address column 66 may store full address information and/or other contact information for each user, e.g. a street name and number, city, zip code, state, email address, etc. A phone number column 68 stores a home phone number for each user. A subscription status column 70 may store, for each user, a value identifying the user's subscription status. That is, different values may be assigned to indicate whether a user has a currently valid subscription, has an expired subscription (and which provides limited access to facility 10), and/or is accessing the facility on a pay-as-you-go basis such as via credit card, etc. It will be appreciated that any information other than that described above may populate the user table 40 without loss of generality.

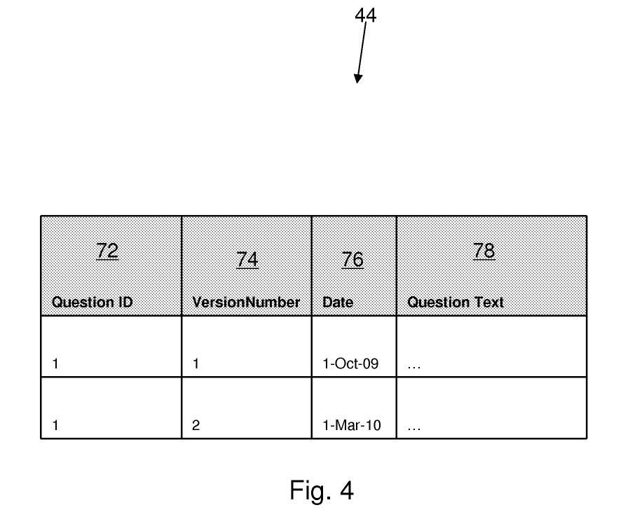

FIG. 4 is diagrammatic representations of an exemplary embodiment of table 44, which is populated with records associated with survey questions used by the amputation prevention facility 10. As shown, this table may include a question ID column 72 to identify the particular survey question, a Version ID column 74 to track versions/updates to the various questions, a date column 76, and a content column 78 populated with the text of the particular question. It will be recognized that the tables 40 and 44 shown in FIGS. 3 and 4 are merely representative, and that one skilled in the art will recognize that more or less information may be included without departing from the scope of the present invention. The skilled artisan will recognize, in view of this disclosure, that a similar approach may be used for tables 45, 46, 51 and 52.

### Amputation Prevention System and Process

As mentioned hereinabove, embodiments of the present invention provide an automated system and method for evaluating and generating protocols for helping to prevent the need for lower extremity amputations. These embodiments enable such evaluation and protocol generation in a real-time, web-based, client-server environment, such as on a subscription or pay-as-you-go basis. While the present invention is discussed within the environment of the exemplary amputation prevention facility 10, it will readily be appreciated that the present invention may be used in any number of environments including network and on-line based transaction facilities in business-to-business, business-to-consumer and consumer-to-consumer applications.

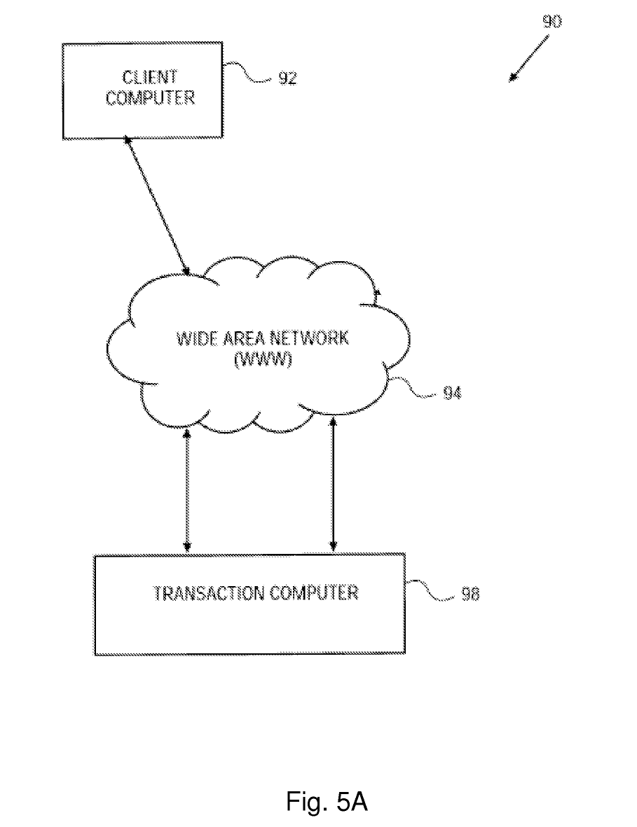

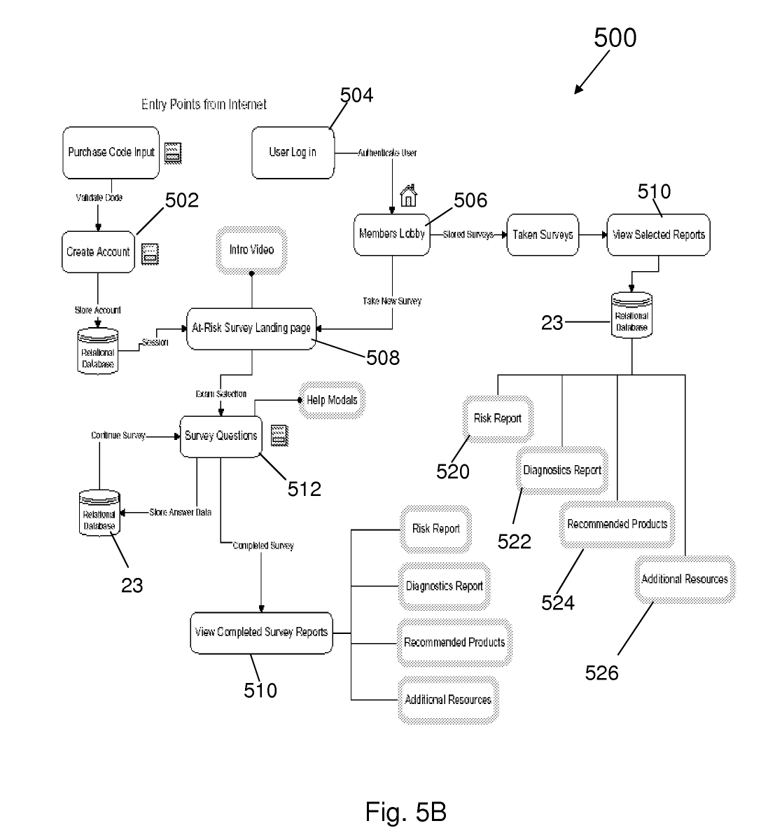

FIG. 5A is a simplified block diagram of a system 90 for generating diagnostic reports in accordance with an exemplary embodiment of the present invention. In this embodiment, a client computer 92 is coupled to a transaction computer 98 via a communications network (e.g. a wide area network) 94. The client computer 92 represents a device that allows a user to interact with the amputation prevention facility 10 or any other transaction facility 98. In one embodiment, the client computer 92 presents to the user an evaluation and protocol generation interface for beginning the evaluation process with the transaction computer 98.

The transaction computer 98, which supports an amputation prevention facility such as shown at 10 of FIG. 1, handles transactions between various participants of the facility 10 including the user of the client computer 92. In one embodiment, the transaction computer 98 may initially receive the personal information of the participant from the client computer 92, and generate a subscription result which determines whether, and to what extent, the user is granted access to the facility 10. The transaction computer may then facilitate access to system, including evaluation and diagnostic report generation in accordance with various user interfaces presented by the computer 98, via the client computer 92, to the user.

FIG. 5B shows a functional block diagram of a system 500 of interfaces/modules, such as may take the form of a series of objects (or methods), that may be implemented by the amputation prevention facility 10, e.g., in combination with the various tables of database 23, for the purposes of patient evaluation and diagnostic report generation, etc. As shown, system 500 includes an account creation module 502 and a login module 504 permitting users to login and gain access to the system. A members lobby module 506 enables access to a view report/research module 510, for viewing generated risk reports 520, diagnostic reports 522, and any recommended products 524 and/or additional resources 526, such as stored in database 23. A Survey Landing module 530 provides user access to the survey questions via survey question module 532, to complete a patient evaluation and generate a diagnostic report, as will be discussed in greater detail hereinbelow. Survey question module 512 also provides access to view report module 510. It should be noted that in addition to enforcing user permissions at the login module 504, such permissions may also be enforced at any one or more of the other aforementioned modules, such as to limit access to any non-anonymous patient records by other users. In this regard, various security algorithms may be employed, such as to permit patients and/or members of a particular patient's team of care providers may be permitted to view only that particular patient's records, while other users, such as health care researchers, insurance companies, or other third party users looking at overall trends, etc., may only be permitted to view aggregated, anonymized records.

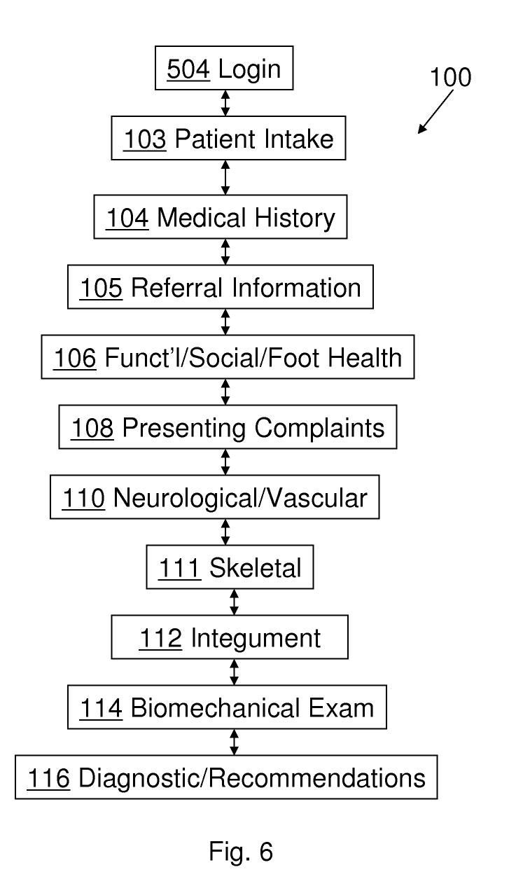

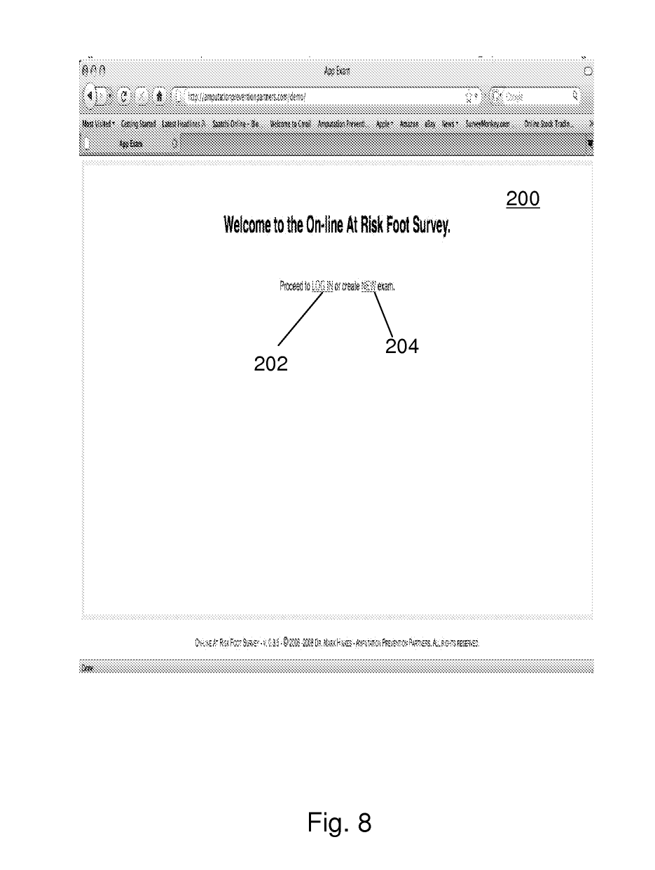

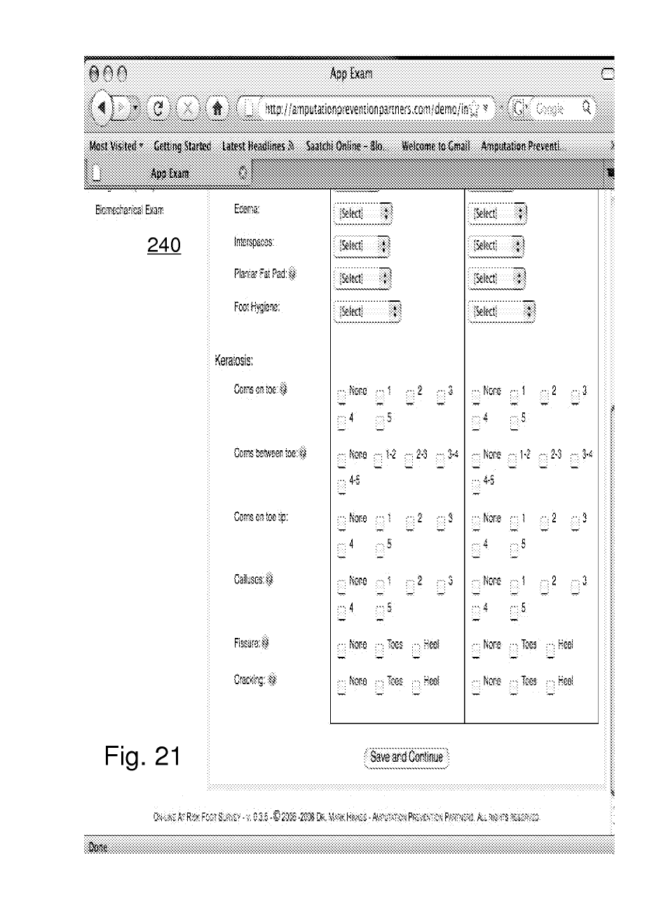

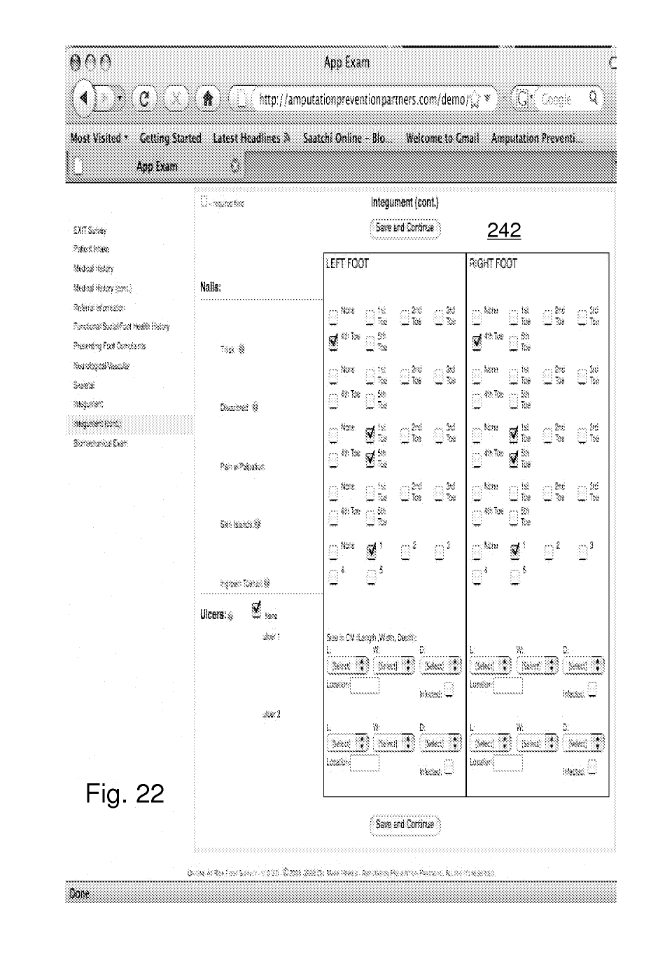

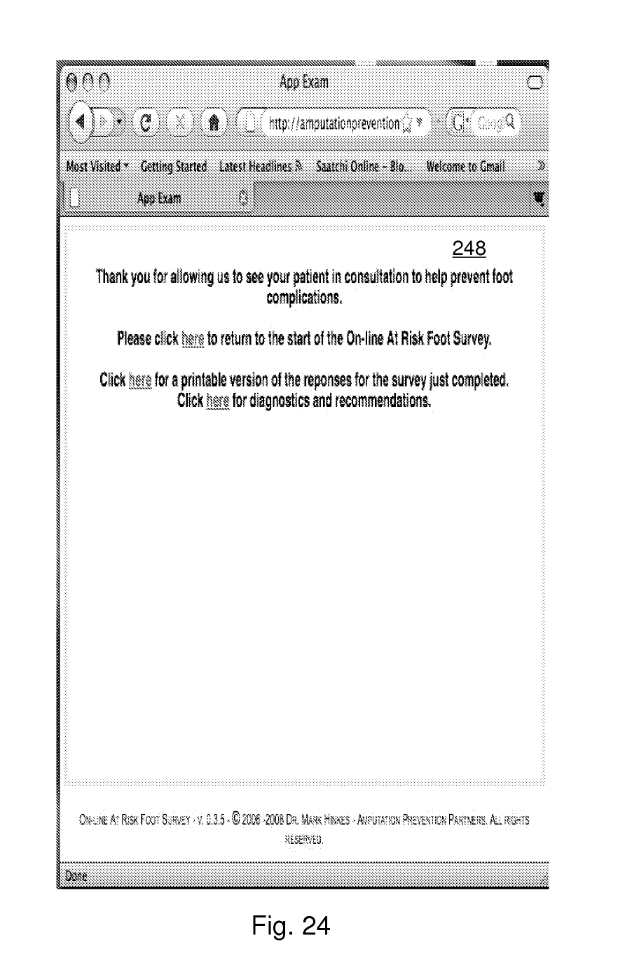

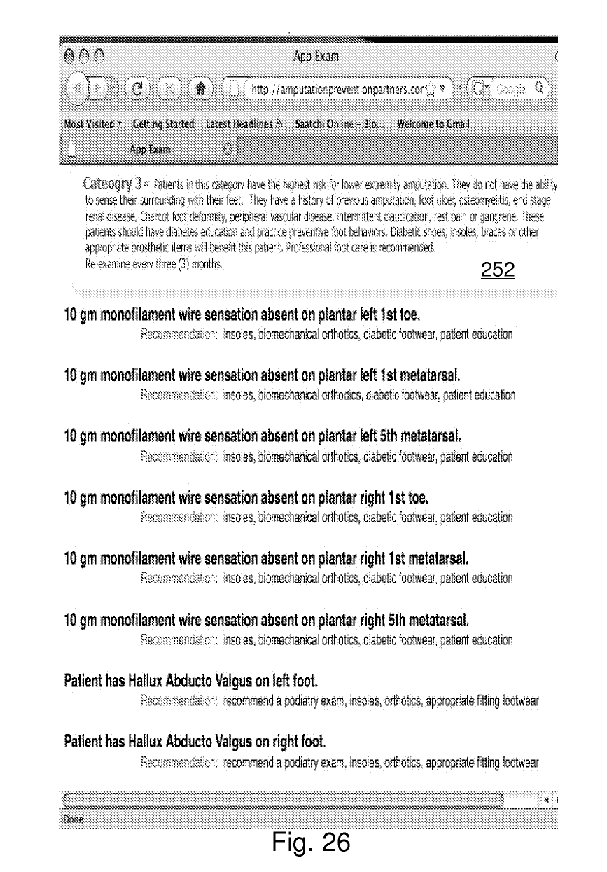

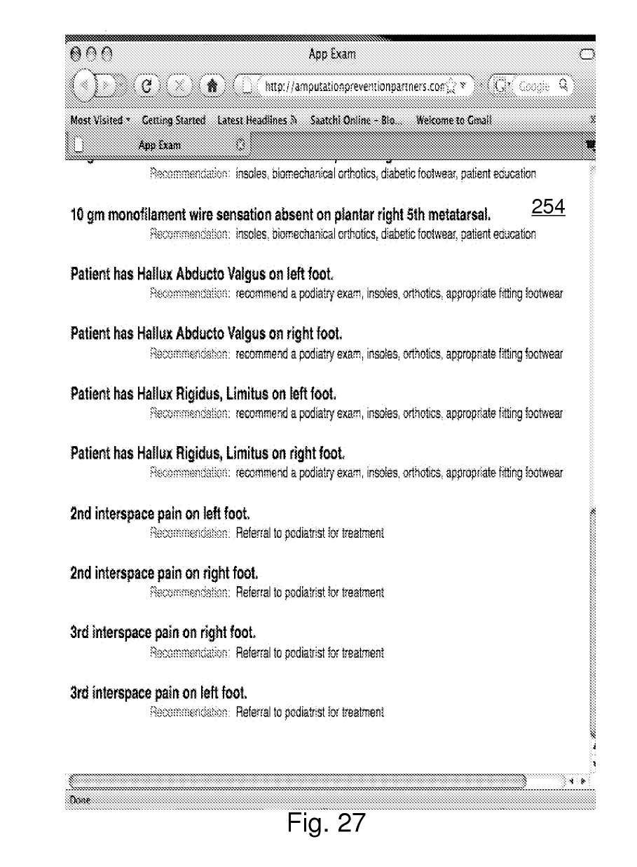

FIG. 6 shows a series 100 of interfaces/modules, such as may take the form of a series of objects (or methods) implemented by facility 10, e.g., by modules 502-512 in combination with the various tables of database 23. Series 100 may thus implement the aforementioned evaluation and report generation. The series 100 of interface modules shown in FIG. 6 will be described with reference to exemplary representations of the various interfaces generated thereby, as shown in FIGS. 8-27.

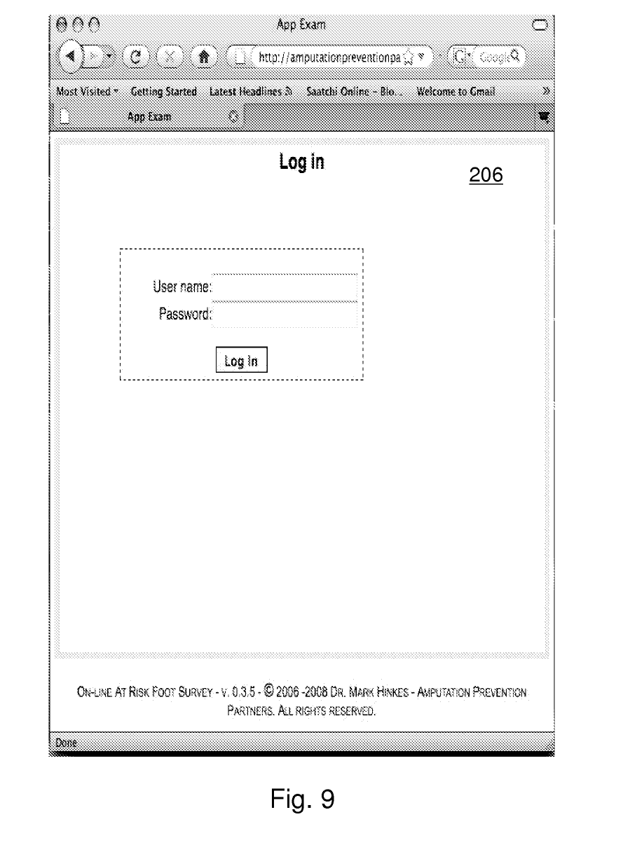

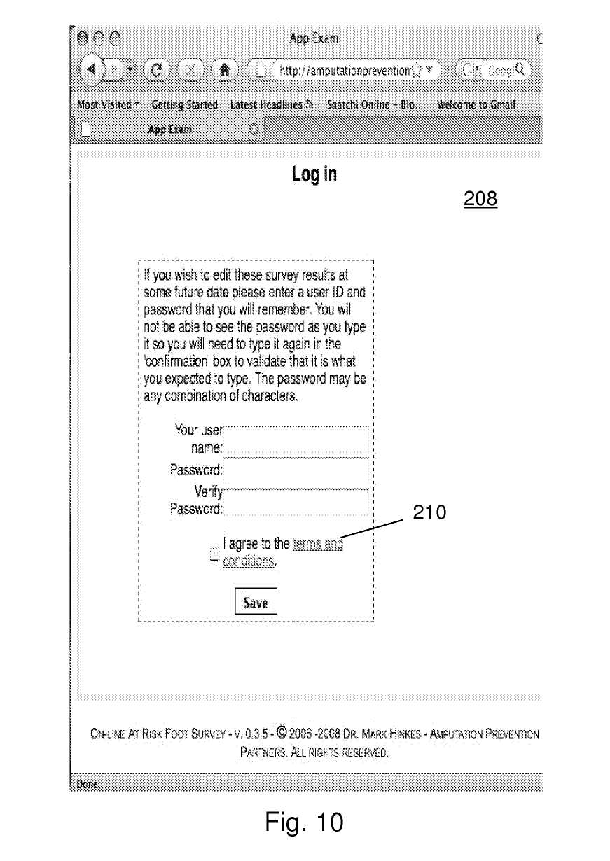

As shown, series 100 includes login module 504, configured to generate a login interface(s) through which a user of the facility 10 provides at least a user identifier and associated password. The user may also be requested to pay a fee for the subscription process. For example, referring to FIG. 8, an At Risk Foot Survey Screen interface 200 may be generated to permit a user to access the survey by either a Login 202 for existing exams or by creating a New Exam at 204. Module 504 may then generate either of two Log In Screens, shown at FIGS. 9 and 10, depending whether the user is going to log in to an existing exam or going to create a new exam. The Log In 206 Screen of FIG. 9 is the location where existing exams may be accessed by Login (User Name) and Password. The Log In Screen 208 of FIG. 10 is the Screen Capture location where New exams may be created by registering with a User Name and Password that is verified. New users may agree to abide by the Terms and Conditions that are provided by a link 210 on this screen.

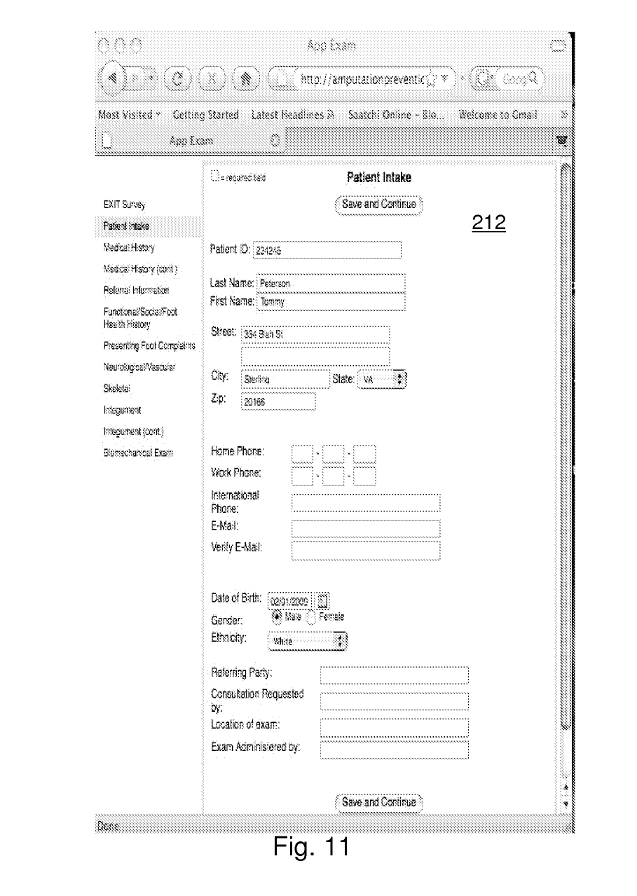

A patient intake module 103 is configured to generate a patient intake 212, such as shown in FIG. 11. Module 103 interacts with the various tables of database 23 (FIG. 1) to enable interface 212 to request and capture various patient information such as: Patient demographic information; Patient referral information; and Test administration information.

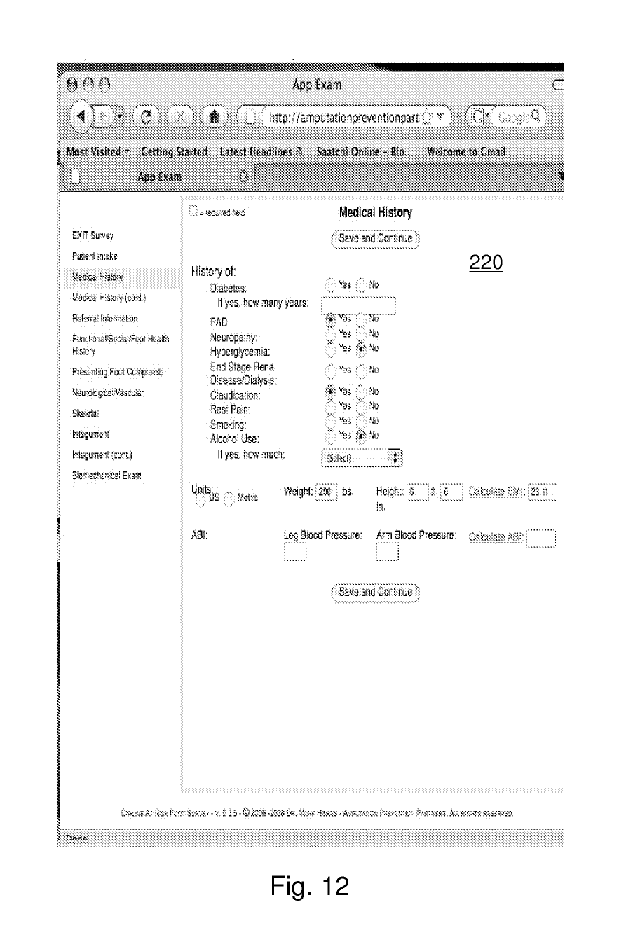

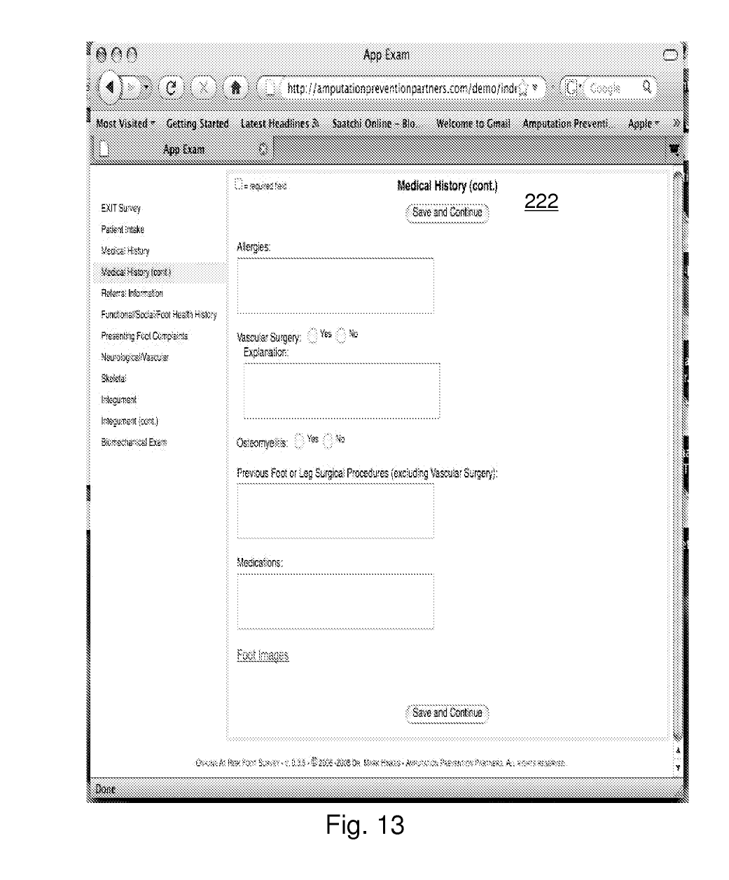

Medical history module 104 is configured to generate a Medical History Screen interface, such as shown at 220 and 222 of FIGS. 12 and 13. In the particular representative embodiments shown, interface 220 of FIG. 12 enables the capture of targeted information concerning various health issues that may present risk factors, and information associated with measuring obesity and circulation. The representative interface 222 of FIG. 13 facilitates the capture of information concerning: Allergies; Previous Vascular Surgery; Previous Bone Infection; Previous Foot or Leg Surgical Procedures; and Medications. As shown, interface 222, in combination with the various tables of database 23, is configured to capture and store images (e.g., photographs) of various views of the patient's feet for visual documentation.

In this regard, it is noted that all of the interfaces discussed herein may be configured to capture and store information in database 23. The various interfaces may also be configured to include links to, or otherwise include, explanatory materials to instruct users such as care providers and/or patients, how to obtain the information requested by that particular interface.

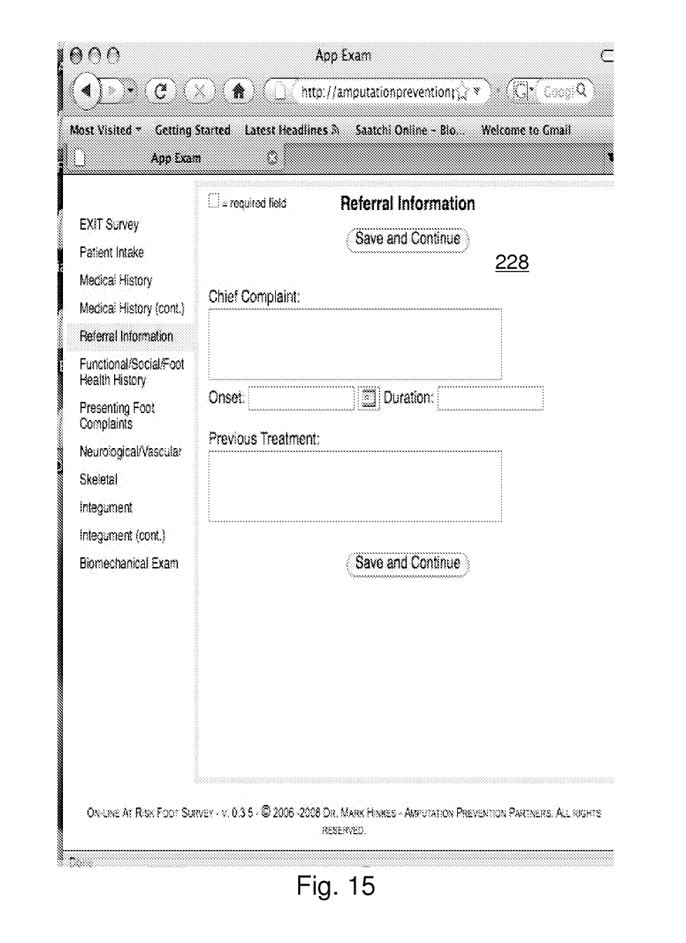

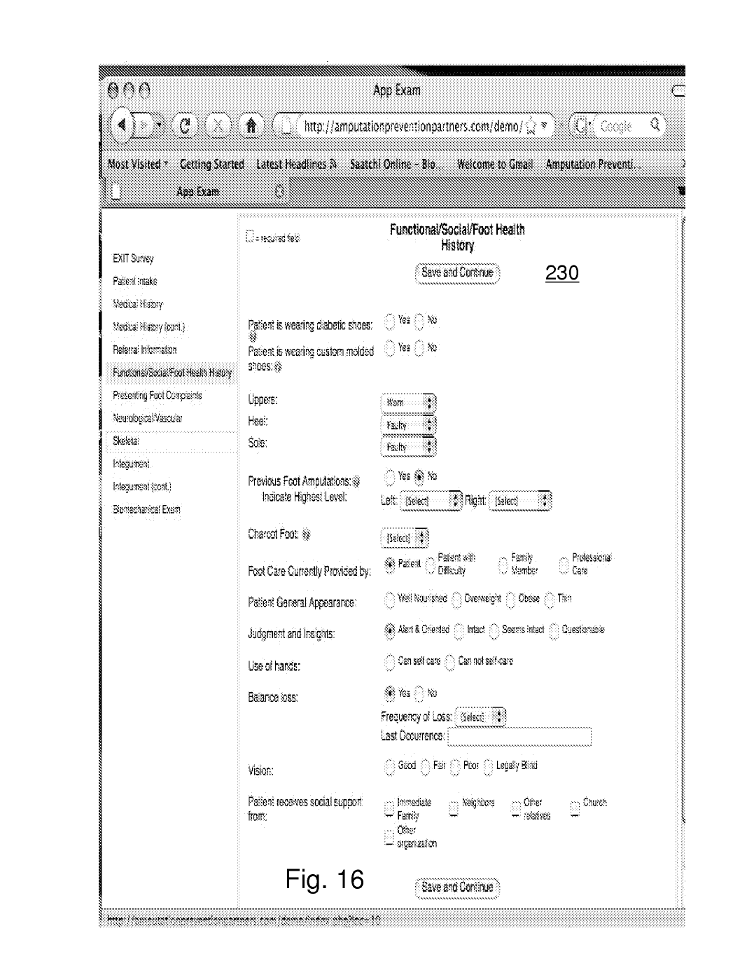

Referral information module 105 is configured to generate a referral interface 228, such as shown in FIG. 15. Foot health module 106 is configured to generate a foot health interface 230 of FIG. 16, which is configured to capture and facilitate storage in information such as: Shoe Evaluation; Previous Amputations; Charcot Foot; Foot Care; Patient Appearance; Use of Hands; Balance and Falling; Vision, and Social support.

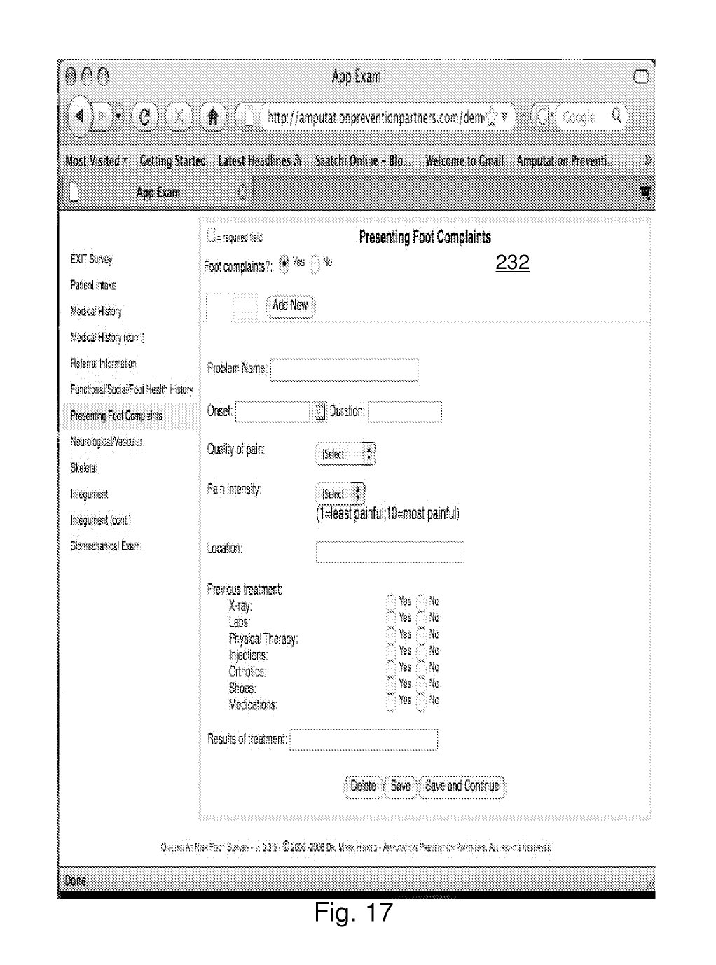

Presenting complaints module 108 generates a Presenting Foot Complaints Screen interface 232, as shown in FIG. 17. This interface 232 is configured to facilitate the capture of information concerning patient's subjective foot complaints. A substantially unlimited number of these screens may be generated. Each Screen 232 may capture and facilitate storage of information such as: a particular complaint; onset and duration of the complaint; quality and intensity of pain; location of the pain; and previous treatments and results.

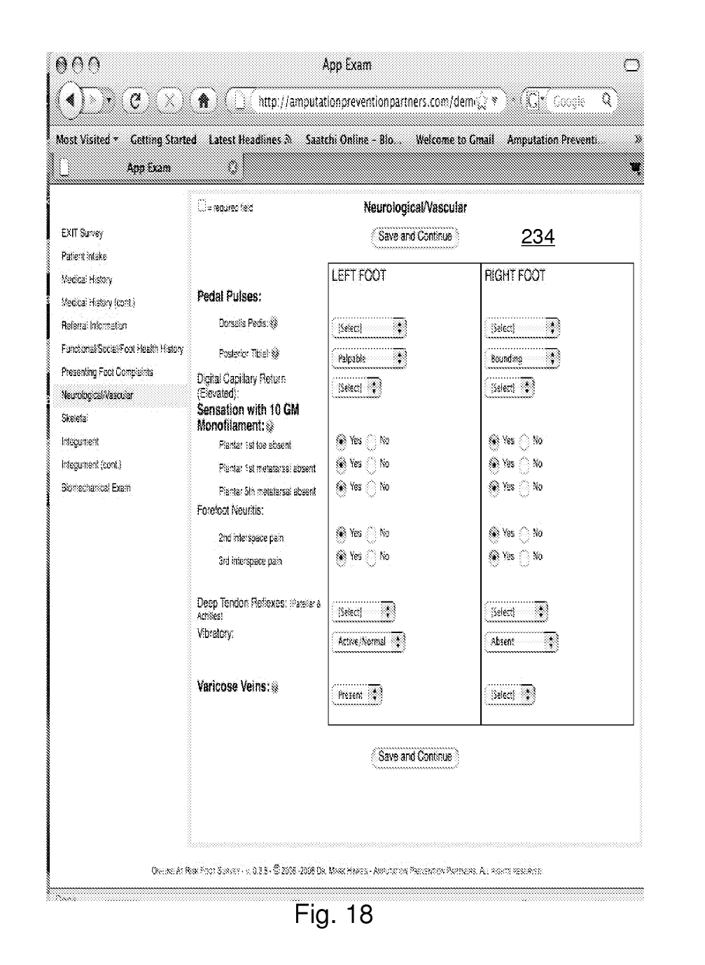

Neurological/Vascular module 110 generates a neurological/vascular screen interface 234 of FIG. 18, which captures information such as: Pedal Pulses; Digital Capillary Return; Varicose Veins; Monofilament Testing Device Results; Forefoot Interspace Pain; and Deep Tendon Reflexes.

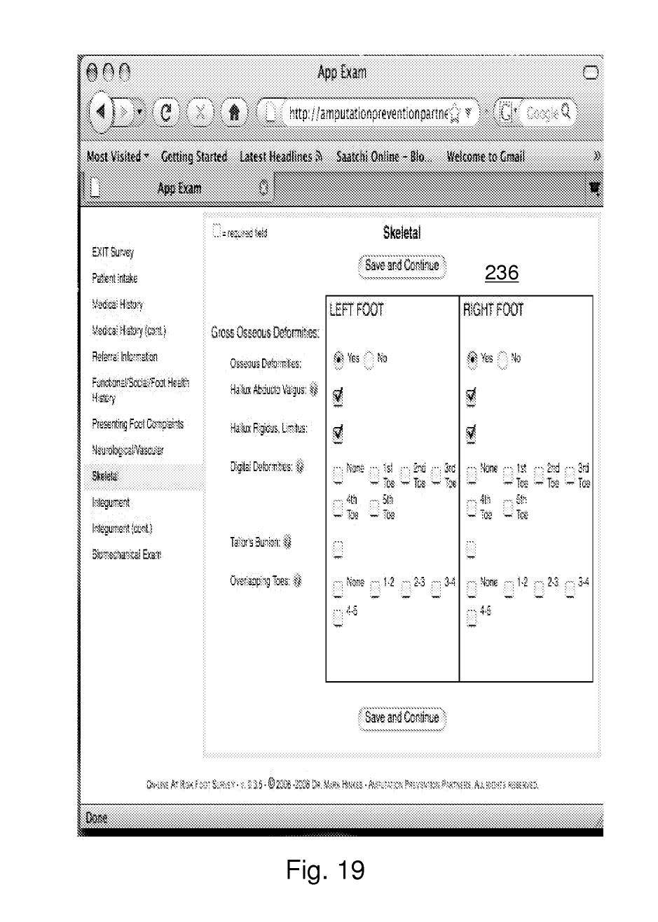

Skeletal module 111 is configured to generate a skeletal interface 236 of FIG. 19, configured to capture information documenting Osseous Deformities, such as: Hallux Abducto Valgus; Hallux Limitus/Rigidus; Digital Deformities (Hammer Toe, Mallet Toe, Claw Toe); Tailor's Bunion; and Overlapping Digits; and Charcot Foot.

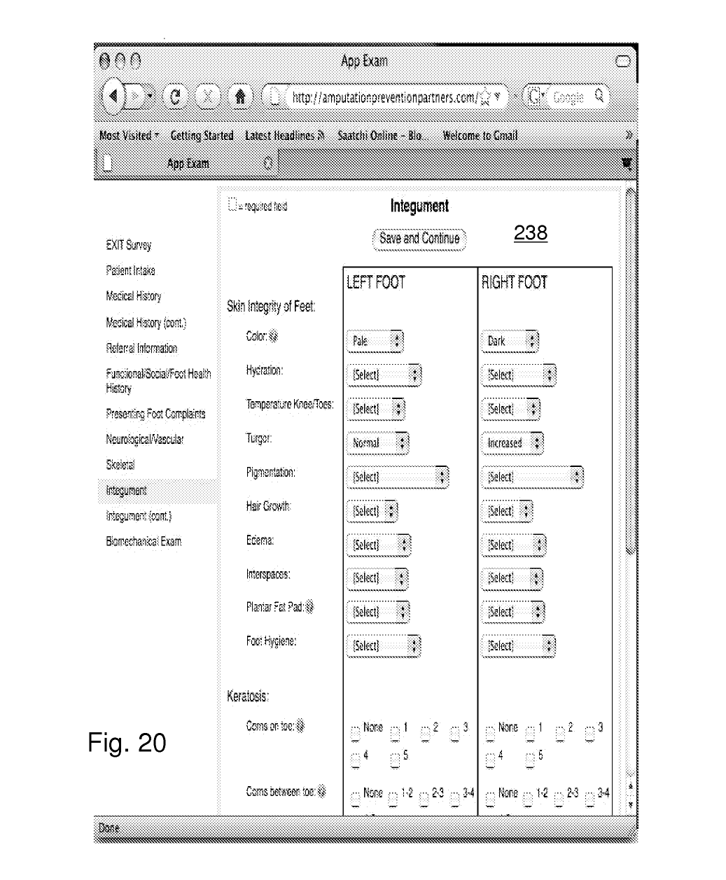

Integument module 112 is configured to generate one or more Integument Screen interfaces, such as shown at 238, 240, 242 of FIGS. 20, 21 and 22, respectively. As shown, these interfaces may capture information on: Integrity of the skin of the legs and feet; Location of Keratosis; Nails; and Ulcers.

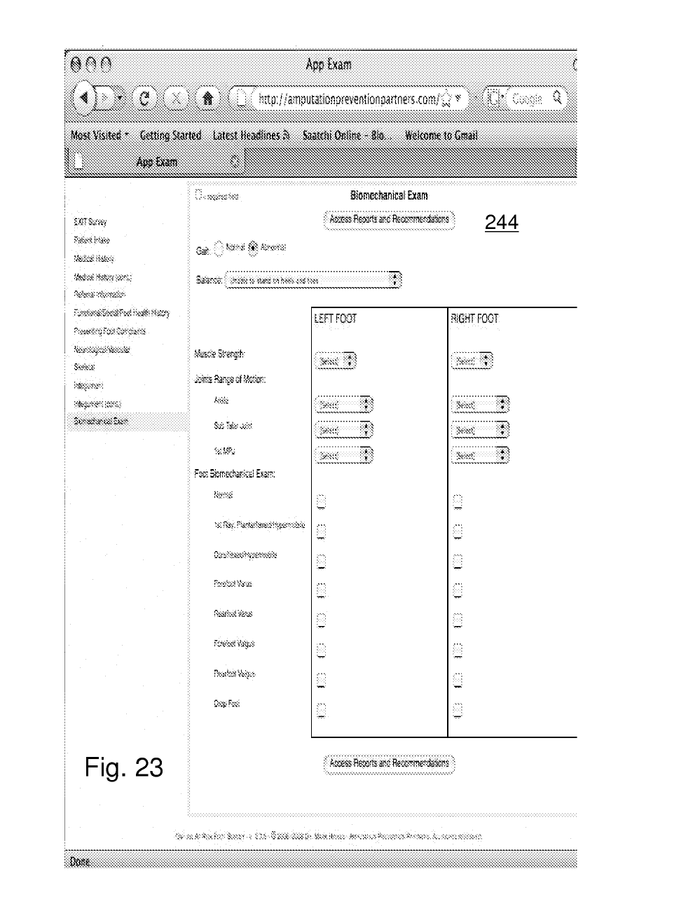

The Biomechanical Exam module 113 is configured to generate a Biomechanical Exam Screen interface 244, such as shown in FIG. 23, for the capture of information such as: Gait; Balance; Muscle Strength; Joints Range of Motion; and Foot Biomechanical Exam.

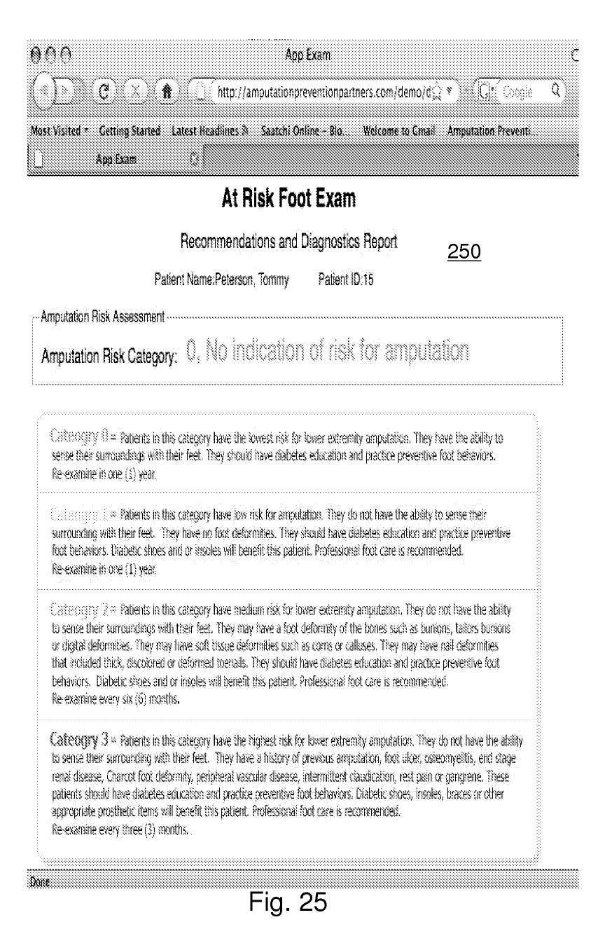

Upon completion of the survey, diagnostic module 116 is configured to generate a completion interface 248, such as to present links to: Return to the beginning of the survey; Review, Print or Export the survey results; and/or to output Diagnostics and Recommendations via Diagnostics/Recommendation interfaces 250, 252, 254 of FIGS. 25-27, respectively.

As shown, interfaces 250, 252, 254 may display recommendations based on the data captured from the particular patient. These interfaces may include an Amputation Risk Assessment and Category, such as shown at 250, an explanation of the Risk Categories, such as shown at 250 and 252, and the identified risk factors and recommendations as shown at 252 and 254. The recommendations may be based on factors including the number, type, and particular combination of the various risk factors identified and captured by the survey interfaces shown and described herein with respect to FIGS. 8-23.

It should be noted that embodiments of the survey/exam provided and/or facilitated by the above-described inventive System (e.g., the inventive “At Risk Foot Survey”) are intended to meet and/or exceed the American Diabetes 2009 Clinical Practice Recommendations concerning “Foot Care.” As shown and described, these recommendations include “inspection, assessment of foot pulses, and testing for loss of protective sensation (10-g monofilament plus testing any one of; vibration using a 128 zHz tuning fork, pin prick sensation, ankle reflexes or vibration perception threshold).” It is also noted that these embodiments are configured to meet and/or exceed guidelines promulgated by the American Society of Endocrinologists.

It is further noted that embodiments of the inventive system and method may be granted a Procedure code number (a CPT code) from the American Medical Association who makes determinations about billing codes for procedures. With such a code number, physicians may use the system (test) in their office and then bill Medicare or private insurance accordingly.

Moreover, it should be recognized that these tests (e.g., use of the inventive System/Survey) may be sold in bulk to managed care companies, HMOs, PPOs and 3rd party administrators, State Health Departments for use in Medicaid type programs, and internationally to Governments, Health Departments, Hospitals, and Clinics. The tests may also be sold at retail, e.g., by creating a blister packed type debit card or small box that would be sold in drug stores, food stores and other retail outlets that would contain a monofilament wire and instructions and a password, etc., for accessing the inventive System online. Still further, the tests may be sold retail at health fairs or be incorporated into “bundled Health Fair products” in which a client pays a global fee and receives multiple health screenings in which a physician reads and interprets the tests.

Aspects of the tests, such as the monofilament wire and instructions/passwords, etc., for accessing the inventive System online may be sold alone or in combination with other related items such as books, CDs or other products related to health care generally or foot and leg care in particular. For example, customers may purchase an inventive System “survey” at a retail outlet or the “survey” may be piggybacked with the sale of a book, such as “Keep The Legs You Stand On” by Dr. Mark Hinkes, DPM (© 2009, Nightengale Press). The survey (e.g., access to the inventive System for a predetermined number of uses and/or a predetermined period of time) may be sold in combination with purchase of the book, such as via a coupon for discounted or free access to the inventive System.

The survey may then be accessed by login and password, e.g., with entry of an additional promotion code which identifies the purchase location/coupon ID # of the survey. In the embodiments of the survey to be sold at retail or which are otherwise targeted towards individual patients, the questions may be tailored for their use, rather than for use by care providers. For example, various questions may be written in the first person, e.g., “Are my toenails thick and discolored?” or “I have thick and discolored toenails”, with provision for the patient to respond, preferably in the yes/no format as much as possible. When desired, drop down boxes may be used to elicit more specific information and/or to provide explanatory material such as mentioned hereinabove.

These embodiments of the survey may collect and analyze data, and provide risk assessments based thereon, substantially as described hereinabove. However, instead of, or in addition to, providing the recommendations discussed above, individual patients (e.g., as determined based on the login/passwords/promotional codes), may be given an educational explanation of their risk factors and encouraged to share this information with their physicians or other health care providers.

It should be further recognized that although the embodiments described above contemplate a server-based application, alternative embodiments may include stand-alone applications configured for running solely or primarily on a user's computer, without departing from the spirit and scope of the present invention.

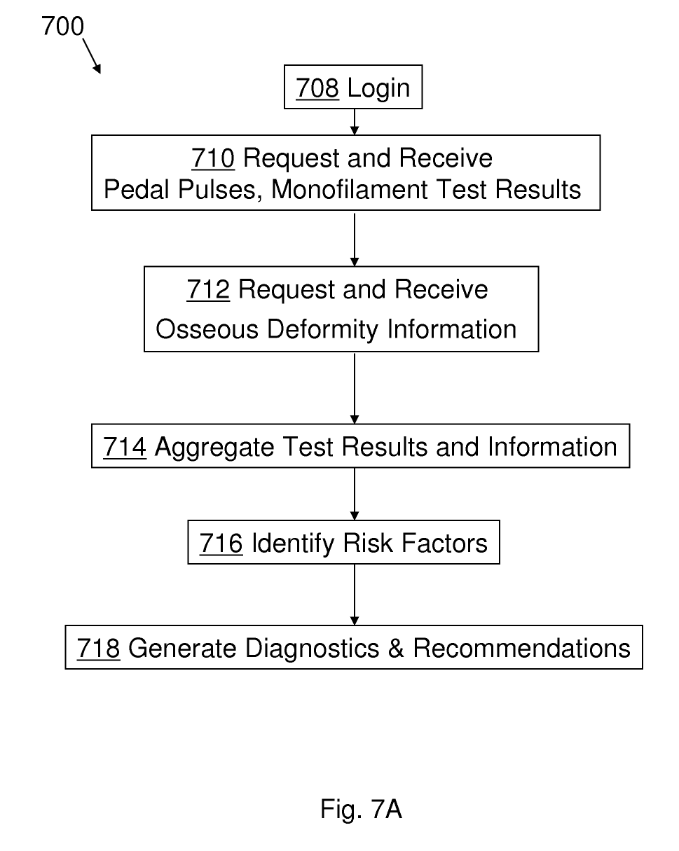

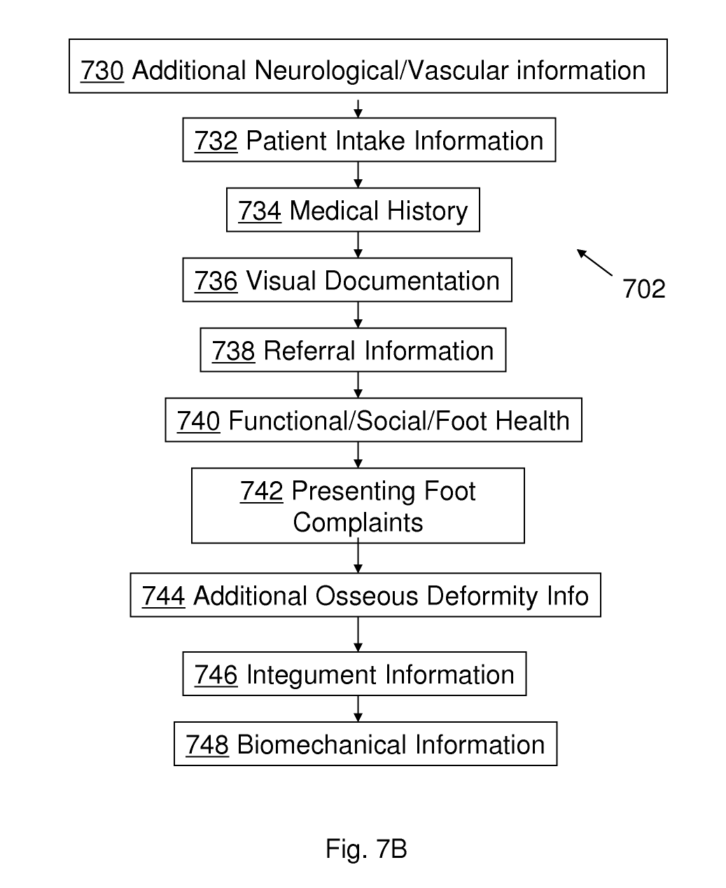

A computer implemented method for evaluating risk factors and generating risk assessments and recommendations for diabetic patients at risk for amputation, in either a stand-alone, or alternatively, a client-server environment using a network-based transaction facility 10, will now be described as illustrated by the flow chart of FIGS. 7A and 7B. As shown in FIG. 7A, the method 700 commences with communicating 708 user interface information to a user of the transaction facility at client 32 (FIG. 1). More specifically, the user interface information may provide a login interface such as shown in FIGS. 8-10, via login module 504, described above with reference to FIG. 6.

Subsequent to the login by the user, e.g., after various optional steps that will be shown and described with respect to FIG. 7B, the user may be provided with a test result interface, such as the interface 234 of FIG. 18, to enable the system to request and receive pedal pulse and monofilament test results at 710. At 712, the system requests and receives Osseous Deformity Information, such as via the skeletal information interface 236 of FIG. 19. The system aggregates the test results and information at 714, and identifies risk factors for amputation using the aggregated information at 716. At 718, the system generates diagnostics and recommendations based on factors such as the amount, type, and particular combination of identified risk factors. The various diagnostics and recommendations include at least one or more of amputation risk assessment categories, explanation of risk categories, identified risk factors, and recommendations for treatment, and may be communicated via the interfaces 250, 252 and/or 254 of FIGS. 25-27.

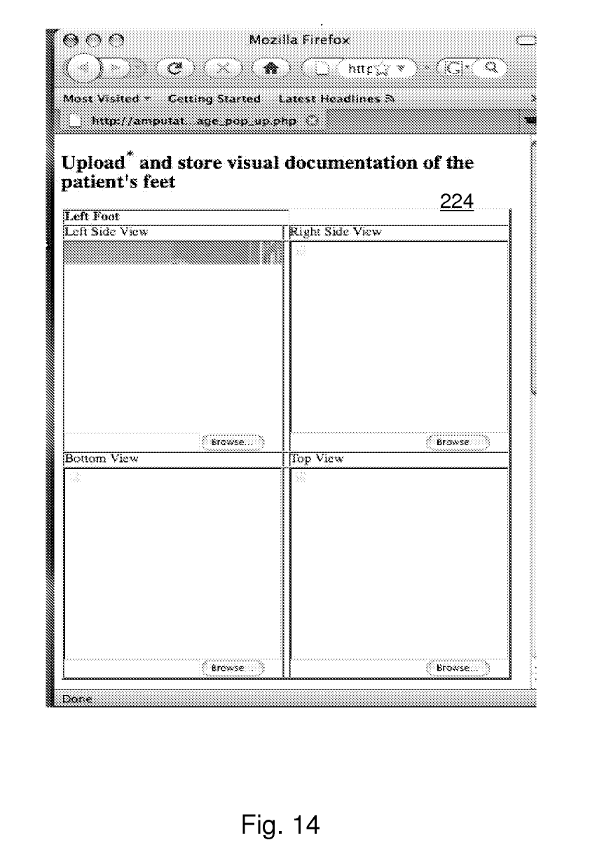

Turning now to FIG. 7B, various steps that may be optionally added to method 700 will be shown and described at 702. It should be recognized that any one or more of these optional steps of 702 may be implemented in combination with the method 700. For example, at 730, additional neurological/vascular information, such as digital capillary return, varicose veins, forefoot interspace pain, and deep tendon reflexes, etc., may be obtained via interface 234 of FIG. 18. Various patient intake information, such as patient demographic information and test administration information, may be gathered at 732, e.g., via interface 212 of FIG. 11. The patient's medical history, including, for example, information related to obesity, circulation, allergies, vascular surgeries, bone infections, foot or leg surgical procedures, and medications, may be captured 734, e.g., via interfaces 220 and 222 of FIGS. 12 and 13. Visual documentation, such as images of the patient's feet, may be collected at 736, via interface 224 of FIG. 14. Patient referral information may be collected 738, via interface 228 (FIG. 15), while information related to functional, social and other foot health issues may be collected at 740. Examples of information collected at 740 include information related to the patient's shoes, previous amputations, charcot foot, general foot care, appearance, use of hands, balance and falling, vision, social support, etc., such as obtained via interface 230 (FIG. 16). At 742, presenting foot complaint information is gathered, such as the onset and duration of complaints, the quality and intensity of pain, location of pain, previous treatments and results, etc., such as gathered via interface 232 (FIG. 17). At 744, any additional Osseous Deformity information, such as Hallux Abducto Valgus, Hallux Limitus/Rigidus, and Digital Deformities including Hammer Toe, Mallet Toe, Claw Toe, Tailor's Bunion, Overlapping Digits, etc., may be collected, e.g., via interface 236 (FIG. 19). At 746, integument information, such as integrity of the skin of the legs and feet, location of Keratosis, condition of nails, ulcers, etc., may be collected via interfaces 238, 240, 242 of FIGS. 20-22. Biomechanical information, such as information relating to gait, balance, muscle strength, joint range of motion, and foot biomechanical examination(s), may be gathered at 748, via interface 244 of FIG. 23.

In summary, it will be appreciated that the above described interfaces, and underlying technologies, provide a convenient computer implemented method for evaluating risk factors and generating risk assessments and recommendations for diabetic patients at risk for amputation, in either a stand-alone, or alternatively, a client-server environment using a network-based transaction facility 10, in a real-time.

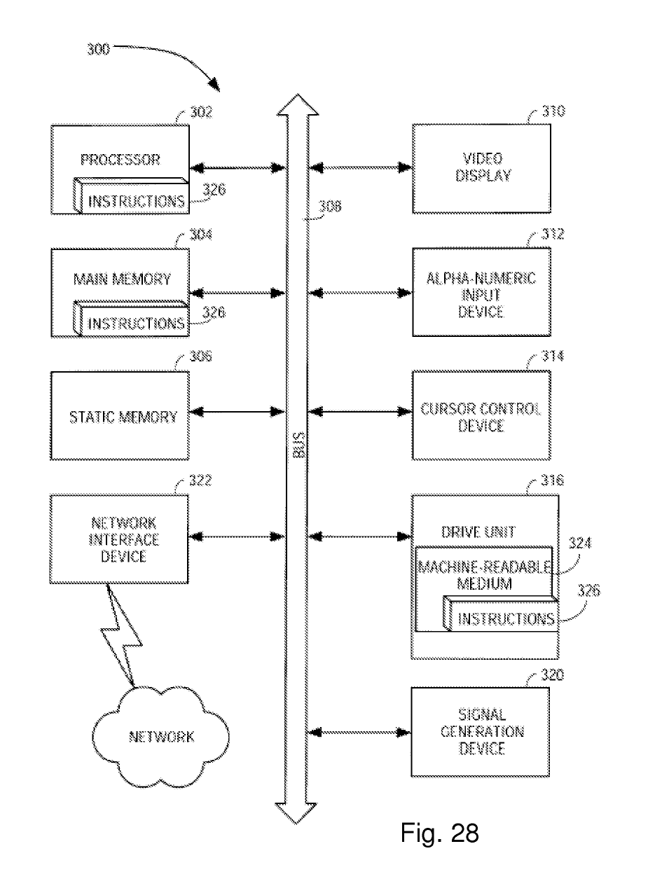

FIG. 28 shows a diagrammatic representation of a machine in the exemplary form of a computer system 300 within which a set of instructions, for causing the machine to perform any one of the methodologies discussed above, may be executed. In alternative embodiments, the machine may include a network router, a network switch, a network bridge, Personal Digital Assistant (PDA), a cellular telephone, a web appliance or any machine capable of executing a sequence of instructions that specify actions to be taken by that machine.

The computer system 300 includes a processor 302, a main memory 304 and a static memory 306, which communicate with each other via a bus 308. The computer system 300 may further include a video display unit 310 (e.g., a liquid crystal display (LCD), plasma, cathode ray tube (CRT), etc.). The computer system 300 may also include an alpha-numeric input device 312 (e.g., a keyboard or touchscreen), a cursor control device 314 (e.g., a mouse), a drive (e.g., disk, flash memory, etc.,) unit 316, a signal generation device 320 (e.g., a speaker) and a network interface device 322.

The drive unit 316 includes a computer-readable medium 324 on which is stored a set of instructions (i.e., software) 326 embodying any one, or all, of the methodologies described above. The software 326 is also shown to reside, completely or at least partially, within the main memory 304 and/or within the processor 302. The software 326 may further be transmitted or received via the network interface device 322. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to include, but not be limited to, solid-state memories, optical and magnetic disks, and carrier wave signals.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

Furthermore, embodiments of the present invention include a computer program code-based product, which includes a computer readable storage medium having program code stored therein which may be used to instruct a computer to perform any of the functions, methods and/or modules associated with the present invention. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

It should be noted that the various modules and other components of the embodiments discussed hereinabove may be configured as hardware, as computer readable code stored in any suitable computer usable medium, such as ROM, RAM, flash memory, phase-change memory, magnetic disks, etc., and/or as combinations thereof, without departing from the scope of the present invention.

It should be further understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

The above systems are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of the present invention may be implemented by one skilled in the art of computer systems and/or software design.

Having thus described the invention, what is claimed is:

1. A computer implemented diagnostic amputation prevention system for evaluating risk factors and generating risk assessments and recommendations for diabetic patients at risk for amputation, the system comprising:
a diagnostic computer having computer readable media with executable computer readable program code disposed thereon, wherein said diagnostic computer includes:
a patient intake module configured to electronically query and receive patient demographic information and test administration information;
a medical history module configured to electronically query and receive patient health information relating to at least one or more of obesity, circulation, allergies, vascular surgeries, bone infections, foot or leg surgical procedures, medications, and combinations thereof;
a visual documentation module configured to electronically query and receive images of the patient's feet;
a referral information module configured to electronically query and receive patient referral information;
a functional/social/foot health module configured to electronically query and receive information related to at least one or more of the patient's shoes, previous amputations, Charcot Foot, Foot Care, Appearance, Use of Hands, Balance and Falling, Vision, Social support, and combinations thereof;
a presenting foot complaints module configured to electronically query and receive information related to at least one or more of patient complaints, onset and duration of the complaints, quality and intensity of pain, location of pain, previous treatments and results, and combinations thereof;
a neurological/vascular module configured to electronically query and receive information related to at least one or more of pedal pulses, digital capillary return, varicose veins, monofilament testing device results, forefoot interspace pain, deep tendon reflexes, and combinations thereof;
a skeletal module configured to electronically query and receive Osseous Deformity information related to at least one or more of Hallux Abducto Valgus, Hallux Limitus/Rigidus, Digital Deformities including Hammer Toe, Mallet Toe, Claw Toe, Tailor's Bunion, Overlapping Digits, Charcot Foot, and combinations thereof;
an Integument module configured to electronically query and receive information related to at least one or more of integrity of the skin of the legs and feet, location of Keratosis, condition of nails, ulcers, and combinations thereof;
a biomechanical exam module configured to electronically query and receive information related to at least one or more of gait, balance, muscle strength, joint range of motion, foot biomechanical exam, and combinations thereof;
a results module is configured to aggregate said information received by said modules to identify risk factors and generate diagnostics and recommendations based on factors including one or more of number, type, and particular combination of identified risk factors, said diagnostics and recommendations selected from the group consisting of amputation risk assessment category, explanation of risk categories, identified risk factors, recommendations for treatment, and combinations thereof.

2. A computer implemented diagnostic amputation prevention system for evaluating risk factors and generating risk assessments and recommendations for diabetic patients at risk for amputation, the system comprising:
a diagnostic computer having computer readable media with executable computer readable program code disposed thereon, wherein said diagnostic computer includes:
a neurological/vascular module configured to electronically query and receive information selected from the group of information consisting of pedal pulses, monofilament testing device results, and combinations thereof;
a skeletal module configured to electronically query and receive Osseous Deformity information;
a database configured to store and aggregate said information received by said modules; and
a results module configured to identify risk factors using the aggregated information and generate diagnostics and recommendations based on factors including amount, type, and particular combination of identified risk factors, said diagnostics and recommendations selected from the group consisting of amputation risk assessment categories, explanation of risk categories, identified risk factors, recommendations for treatment, and combinations thereof.

3. The system of claim 2, wherein the group of information further comprises information regarding at least one of digital capillary return, varicose veins, forefoot interspace pain, deep tendon reflexes, and combinations thereof.

4. The system of claim 2, further comprising a patient intake module configured to electronically query and receive at least one of patient demographic information and test administration information.

5. The system of claim 2, further comprising a medical history module configured to electronically query and receive patient health information selected from the group consisting of information related to obesity, circulation, allergies, vascular surgeries, bone infections, foot or leg surgical procedures, medications, and combinations thereof.

6. The system of claim 2, further comprising a visual documentation module configured to electronically query and receive images of the patient's feet.

7. The system of claim 2, further comprising a referral information module configured to electronically query and receive patient referral information.

8. The system of claim 2, further comprising a functional/social/foot health module configured to electronically query and receive information selected from the group consisting of the patient's shoes, previous amputations, Charcot Foot, Foot Care, Appearance, Use of Hands, Balance and Falling, Vision, Social support, and combinations thereof.

9. The system of claim 2, further comprising a presenting foot complaints module configured to electronically query and receive information selected from the group consisting of patient complaints, onset and duration of the complaints, quality and intensity of pain, location of pain, previous treatments and results, and combinations thereof.

10. The system of claim 2, wherein the skeletal module is configured to electronically query and receive Osseous Deformity information selected from the group consisting of Hallux Abducto Valgus, Hallux Limitus/Rigidus, Digital Deformities including Hammer Toe, Mallet Toe, Claw Toe, Tailor's Bunion, Overlapping Digits, Charcot Foot, and combinations thereof.

11. The system of claim 2, further comprising an Integument module configured to electronically query and receive information selected from the group consisting of integrity of the skin of the legs and feet, location of Keratosis, condition of nails, ulcers, and combinations thereof.

12. The system of claim 2, further comprising a biomechanical exam module configured to electronically query and receive information selected from the group consisting of gait, balance, muscle strength, joint range of motion, foot biomechanical exam, and combinations thereof.

13. The system of claim 2, disposed within a client-server environment, wherein said diagnostic computer comprises a server configured to generate a plurality of user interfaces displayable on a client computer, said server being responsive to information entered via the user interfaces on the client computer.

14. The system of claim 13, comprising a research module communicably coupled to the database, the research module configured for enabling users to access the aggregated information for a plurality of patients.

15. A computer implemented method for evaluating risk factors and generating risk assessments and recommendations for diabetic patients at risk for amputation, the method comprising:
(a) querying and receiving, with a neurological/vascular computer module, information relating to at least one of pedal pulses, monofilament testing device results, and combinations thereof;
(b) querying and receiving, with a skeletal computer module, Osseous Deformity information; and
(c) aggregating, in a database, the information received during said querying and receiving (a) and (b);
(d) identifying, with a results computer module, risk factors for amputation using the aggregated information; and
(e) generating, with the results computer module, diagnostics and recommendations based on factors including amount, type, and particular combination of identified risk factors, the diagnostics and recommendations including at least one or more of amputation risk assessment categories, explanation of risk categories, identified risk factors, recommendations for treatment, and combinations thereof.

16. The method of claim 15, wherein said querying and receiving (a), further comprises querying and receiving, with the neurological/vascular computer module, information regarding digital capillary return, varicose veins, forefoot interspace pain, deep tendon reflexes, and combinations thereof.

17. The method of claim 15, further comprising querying and receiving, with a patient intake computer module, patient demographic information and test administration information.

18. The method of claim 15, further comprising querying and receiving, with a medical history computer module, patient health information selected from the group consisting of information related to obesity, circulation, allergies, vascular surgeries, bone infections, foot or leg surgical procedures, medications, and combinations thereof.

19. The method of claim 15, further comprising querying and receiving, with a visual documentation computer module, images of the patient's feet.

20. The method of claim 15, further comprising querying and receiving, with a referral information computer module, patient referral information.

21. The method of claim 15, further comprising querying and receiving, with a functional/social/foot health computer module, information selected from the group consisting of the patient's shoes, previous amputations, Charcot Foot, Foot Care, Appearance, Use of Hands, Balance and Falling, Vision, Social support, and combinations thereof.

22. The method of claim 15, further comprising querying and receiving, with a presenting foot complaints computer module, information selected from the group consisting of patient complaints, onset and duration of the complaints, quality and intensity of pain, location of pain, previous treatments and results, and combinations thereof.

23. The method of claim 15, wherein said querying and receiving (b) further comprises querying and receiving, with the skeletal computer module, Osseous Deformity information selected from the group consisting of Hallux Abducto Valgus, Hallux Limitus/Rigidus, Digital Deformities including Hammer Toe, Mallet Toe, Claw Toe, Tailor's Bunion, Overlapping Digits, Charcot Foot, and combinations thereof.

24. The method of claim 15, further comprising querying and receiving, with an Integument computer module, information selected from the group consisting of integrity of the skin of the legs and feet, location of Keratosis, condition of nails, ulcers, and combinations thereof.

25. The method of claim 15, further comprising querying and receiving, with a biomechanical exam computer module, information selected from the group consisting of gait, balance, muscle strength, joint range of motion, foot biomechanical exam, and combinations thereof.

26. The method of claim 15, being implemented within a client-server environment, wherein a server computer is configured to generate a plurality of user interfaces displayable on a client computer to query a user, the server being responsive to information entered via the user interfaces on the client computer to receive the information.

27. An article of manufacture for evaluating risk factors and generating risk assessments and recommendations for diabetic patients at risk for amputation, said article of manufacture comprising: a computer usable medium having a computer readable program code embodied therein, for performing the steps of claim 15.
